(19) United States
(12) Patent Application Publication
(10) Pub. No.: US 2010/0158697 A1
(43) Pub. Date: Jun. 24, 2010

(54) MULTI-ROTOR VERTICAL AXIS WIND TURBINE

(75) Inventor: Young-Hwa Kim, Hudson, WI (US)

Correspondence Address: SHUMAKER & SIEFFERT, P. A., 1625 RADIO DRIVE, SUITE 300, WOODBURY, MN, 55125, US

(73) Assignee: Higher Dimension Materials, Inc., Oakdale, MN (US)

(21) Appl. No.: 12/643,777

(22) Filed: Dec. 21, 2009

Related U.S. Application Data
(60) Provisional application No. 61/203,266, filed on Dec. 19, 2008.

(51) Int. Cl. F03D 3/06

(52) U.S. Cl. 416/243; 416/223 R

(57) ABSTRACT

New aerodynamically improved rotors for use in vertical axis wind turbine (VAWTs) are disclosed. In some examples, the VAWT rotors include one or more blades with an aerodynamic front shape with low drag coefficient and a blunt or concave back shape that effectively catches the wind. Example rotors can be used by themselves or in conjunction with vertically attached rotating airfoils. The new rotors add to the overall energy production while acting as supports for the vertical airfoils. Furthermore, the new rotors provide energy in low wind speed conditions where the vertical airfoils are ineffective and can act as jump starters for the vertical airfoils. Guy wire structures for stabilizing VAWTs are also disclosed. The structures allow for reduced construction costs for a given tower height compared to conventional HAWTs and allows for taller towers for a given construction cost. The overall stability under wind gusts is improved by the guy wire design

This application claims the benefit of U.S. Provisional Application No. 61/203,266, titled “MULTI-ROTOR VERTICAL AXIS WIND TURBINE,” and filed Dec. 19, 2008, the entire content of which is incorporated herein by reference.

### TECHNICAL FIELD

The disclosure generally relates to wind turbines and, more particularly, vertical axis wind turbines.

### BACKGROUND

Traditional wind turbines consist of rotors comprising multiple blades rotating on a horizontal axis. These turbines are held up by a tower that elevates the rotor to a position where the wind is stronger than at ground level. The tower must be stable enough to balance forces generated by wind incident on the rotor. This increases the cost of the tower and the foundation and thus increases the overall cost of the turbine. For the turbine to be efficient, the rotor must be directed to point into the wind. For smaller windmills this is achieved through a wind vane. For larger wind turbines, this can be achieved through a yaw control motor, but this motor would add weight to the top of the wind turbine tower thus increasing construction costs of the tower. Another issue is that the wind speed at the top of the rotor is generally higher than at the bottom of the rotor. This produces a cyclic stress on the blades, axel, and bearings that have been known to cause turbine failures.

Vertical-Axis Wind Turbines (VAWT), which rotate in the horizontal plane offer many advantages over Horizontal-Axis Wind Turbines (HAWT), which rotate in the vertical plane, including independence on wind direction and, for some models, improved performance in low wind conditions. Another advantage is the capability of locating the generator and gearbox at the ground level which allows for reduced tower costs since the tower doesn't need to support the generator weight and for reduced maintenance costs since the generator and gearbox are readily accessible. The main disadvantage of some VAWTs is that it has proven difficult to achieve an efficient wind turbine design when the wind direction is perpendicular to the rotation axis.

### SUMMARY

In general, the disclosure relates to VAWTs that may provide for efficient production energy from wind power. In some example, a VAWT may include one or more rotors configured to rotate about a rotational axis defined by the major axis of a longitudinal support member. The rotors may include one or more rotor blades configured to provide for rotation of the rotor about the rotational axis via wind power, where the structure configuration of the blades may increase the efficiency of the rotor. In some examples, the rotors may be coupled to vertical airfoils.

In one embodiment, the disclosure is directed to a vertical axis wind turbine assembly comprising a longitudinal support member defining a vertical rotational axis; and at least one vertical axis rotor, the vertical axis rotor including at least one rotor blade configured to rotate about the vertical rotational axis along a rotational plane substantially orthogonal to the vertical rotational axis, wherein the rotor blade extends radially outwardly from the vertical rotational axis along a nonlinear path in the rotational plane, and including a concave cross-section that tapers toward a distal end of the blade.

In another embodiment, the disclosure is directed to a vertical axis wind turbine assembly comprising a longitudinal support member defining a vertical rotational axis; and at least one vertical axis rotor, the vertical axis rotor including at least one rotor blade configured to rotate about the vertical rotational axis along a rotational plane substantially orthogonal to the vertical rotational axis, wherein the rotor blade includes a leading edge and trailing edge extending from an inner diameter to an outer diameter of the circular path followed by the at least one rotor blade about the rotational axis, and a distal portion and a proximal portion with respect to the vertical rotational axis, wherein the trailing edge of the proximal portion exhibits a first drag coefficient that is greater than: a second drag coefficients exhibited by the leading edge of the proximal portion; a third drag coefficient exhibited by the leading edge of the distal portion; and a fourth drag coefficient exhibited by the trailing edge of the distal portion.

In another embodiment, the disclosure is directed to a vertical axis wind turbine assembly comprising a longitudinal support member defining a vertical rotational axis; and a plurality of turbines each coupled to the longitudinal support member at different vertical positions, wherein each turbine comprises at least one vertical axis rotor, the vertical axis rotor including at least one rotor blade configured to rotate about the vertical rotational axis along a rotational plane substantially orthogonal to the vertical rotational axis, wherein the rotor blade includes a leading edge and trailing edge extending from an inner diameter to an outer diameter of the circular path followed by the at least one rotor blade about the rotational axis, and a distal portion and a proximal portion with respect to the vertical rotational axis.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIGS. 1A-1L show an example vertical-axis rotor blade.

FIGS. 2A-2C show an example rotor.

FIGS. 3A-3K show alternate embodiments of an example rotor.

FIGS. 4A-4J show alternate embodiments of an example rotor blade.

FIGS. 5A-5C show alternate embodiments of an example rotor blade.

FIGS. 6A-6K show alternate embodiment of an example rotor.

FIGS. 7A-7C show embodiments of an example turbine.

FIGS. 8A-8B show an example turbine.

FIG. 9 shows airflow with no angle of attack past an example airfoil.

FIG. 10 shows airflow with an angle of attack past an example airfoil.

FIGS. 11A-11R show other embodiments of an example turbine.

FIGS. 12A-12D show other embodiments of an example turbine.

FIGS. 13A-13B show one or more instances of an example turbine on a tower.

FIG. 14 shows a top view of example spreader beams.

FIG. 15 shows a top view of an array of an example turbines.

FIG. 16 shows a bird's eye view of an array of an example rotors.

Like drawings include like elements.

### DETAILED DESCRIPTION

There are several types of VAWT that have been considered. These VAWTs can be divided into three major categories: drag-based designs, lift-based designs, and hybrid designs. An example of a drag-based design is the cupped anemometer where several (usually 3 or 4) cups are supported radially from a vertical rotation axis. The cups have a higher drag coefficient on one side than the other and the associated difference in force drives the rotor. A variation on this basic idea is the Savonius rotor (U.S. Pat. No. 1,766,765), which replaces the cup of the anemometer with hollow half cylinders. The main advantage of drag-type VAWTs are the independence from wind direction and the simplicity of design. The main disadvantage is the relatively low efficiency of typically 15-20%.

HAWTs can achieve high efficiency (about 40-50%) when the blade speed exceeds the wind speed through a lift mechanism. VAWTs can also make use of a lift mechanism by using airfoils such as, e.g., in U.S. Pat. No. 1,835,018 to Darrieus et al. In some aspects, the Darrieus et al. design uses several airfoils (typically 2 or 3) arranged into an egg-beater shape. When the airfoils are rotating and a wind is present a lift is generated that has a component in the direction of motion. This lift provides energy to the turbine. A variation on the Darrieus design is the H-rotor or Giromill which uses several (typically 2 or 3) vertically oriented airfoils and works with the same lift mechanism as the Darrieus design. The H-rotor has the advantage that the full length of the airfoil is fully utilized while the eggbeater shape of the Darrieus et al. rotor does not effectively utilize the airfoil area near the top and bottom of the tower axis.

However, in practice the potential improvement in efficiency in the H-rotor design is offset by aerodynamic drag on the struts supporting the airfoils. The efficiency of the lift-type VAWTs is about 30-40%. This improved efficiency over drag-type designs is an advantage to lift-type VAWTs. However, the efficiency still may not be quite as high as traditional HAWTs. A main disadvantage to lift-type VAWTS is that they are typically not self-starting because the torque that is generated by lift is only effective when the airfoils are already moving. They also generate cyclically varying torques which puts stresses on the tower structure and contributes to reliability issues.

Even though the efficiency of current VAWTs are not as high as HAWTs, the advantages that an optimized VAWT could offer over the current HAWTs has inspired much research into VAWT technology.

As will be described in further detail below, in accordance with some embodiments of the disclosure, new rotors are described that allow for efficient energy production in a VAWT. For example, in some embodiments, aerodynamically improved rotors for use in improved VAWTs may provide for efficient production of energy from wind power. In some examples, a rotor may have multiple blades that include an aerodynamic front shape with low drag coefficient and a blunt back shape that effectively catches the wind. Examples of the rotors can have horizontal airfoil-shaped sections, e.g., sections at or near the ends of the rotor blades. The new rotors can be used by themselves or in conjunction with vertically oriented rotating airfoils in configuration similar to that of H-rotors. The new rotors are more efficient than Savonius rotors and when integrated into a hybrid design with rotating vertical airfoils, may not substantially interfere with the performance of the vertical airfoils and, in contrast to the drag-inducing supporting struts in conventional H-rotor designs, the new rotors add to the overall energy production while acting as supports for the vertical airfoils.

Furthermore, the example rotor configurations described herein may provide energy in low wind speed conditions where the vertical airfoils are ineffective and can act as jump starters for the vertical airfoils. Some embodiments may also provide for an alternative configuration for the vertically oriented airfoil that removes the conventional constraint that the airfoils move along a circular path. In this case the vertically oriented airfoils are supported by an assembly that allows them to move along a path that is chosen to optimize energy production. Some embodiments may also provides for a construction of arrays of VAWTs that are supported by guy wires between nearby towers and between towers and the ground. Such a guy wire assembly allows for reduced tower costs for a given tower height or for increased tower height for a given tower cost invention.

As described herein, in general, a vertical axis wind turbine may include a longitudinal support member and at least one vertical axis rotor. The longitudinal support member may define a vertical rotational axis. The vertical axis rotor(s) may include one or more rotor blades that rotate about the vertical rotational axis along a rotational plane substantially orthogonal to the vertical rotational axis. The rotor(s) may drive a turbine shaft, e.g., as part of the longitudinal support member, via rotational motion generated by wind acting on the rotors to produce, for example, electricity.

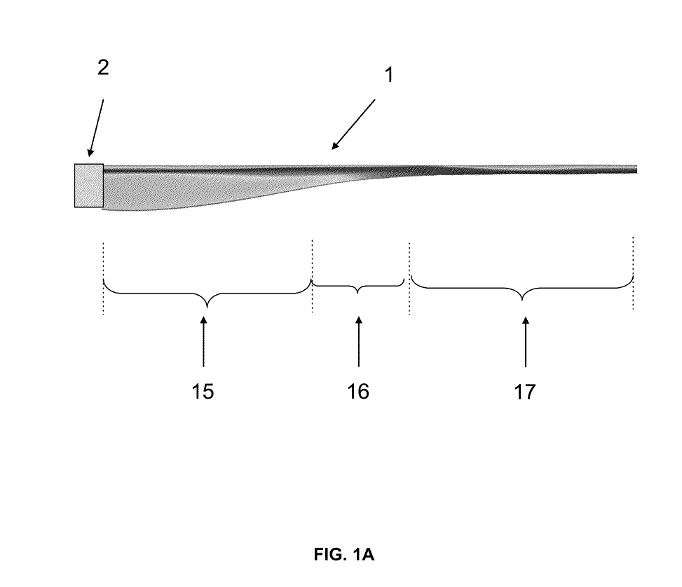

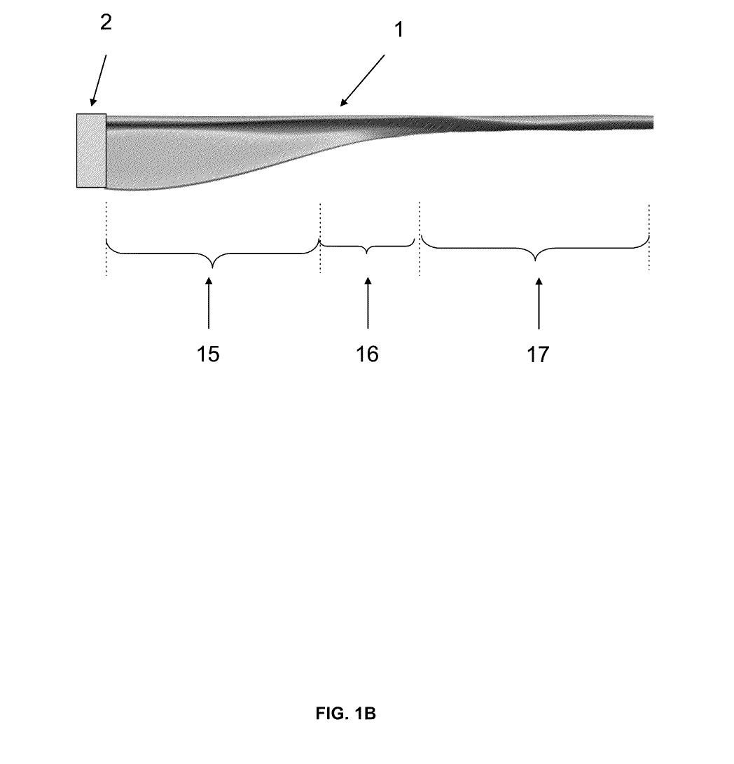

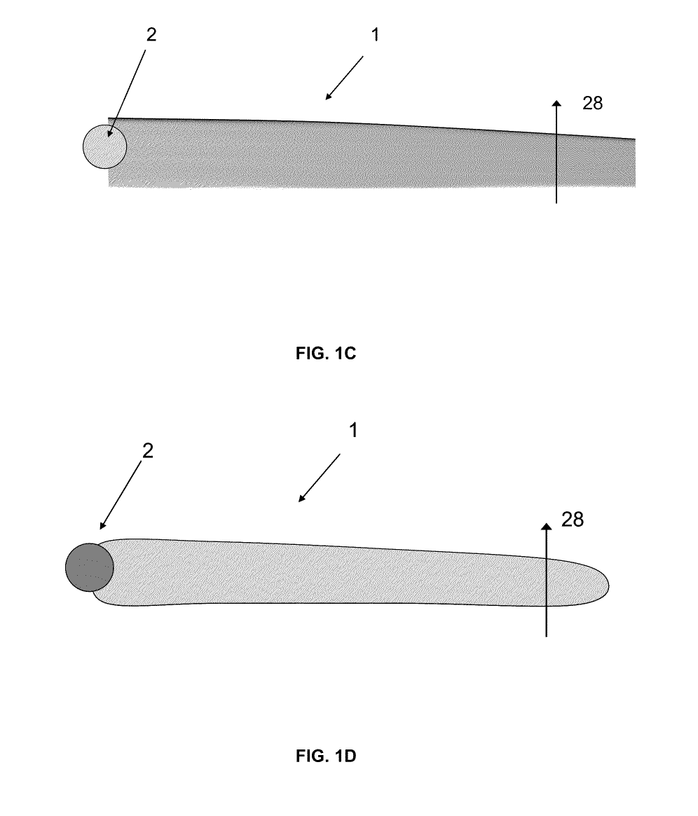

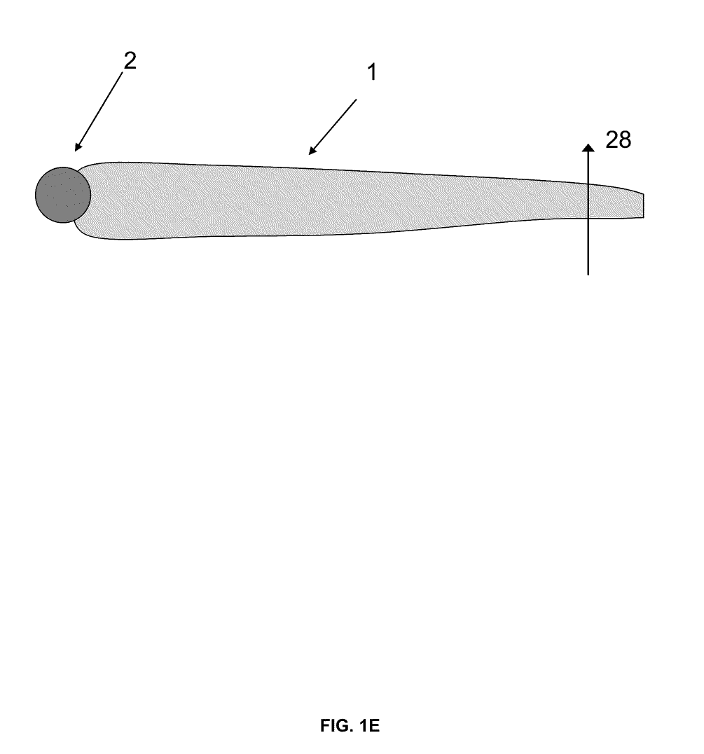

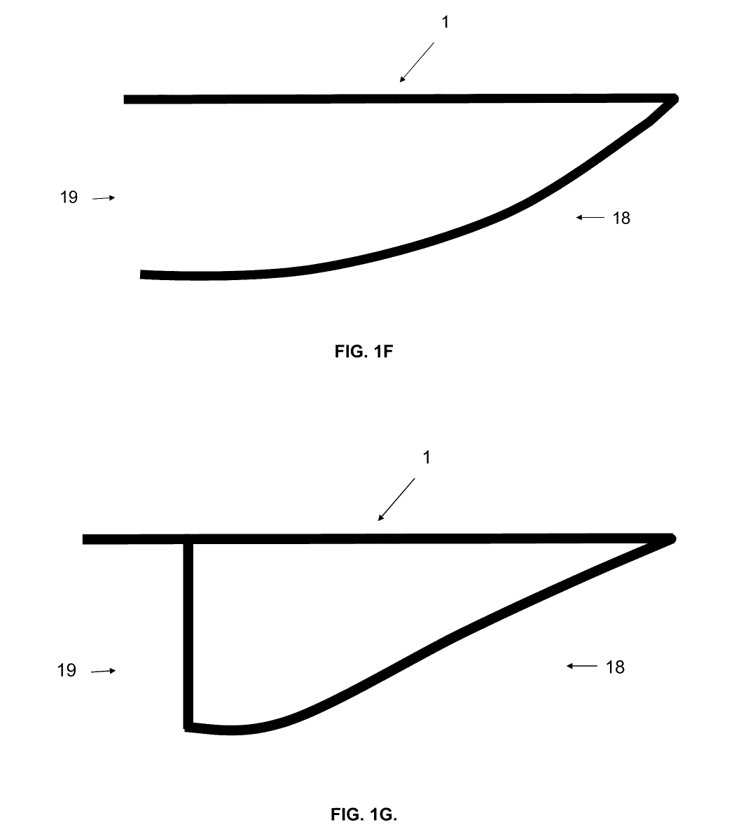

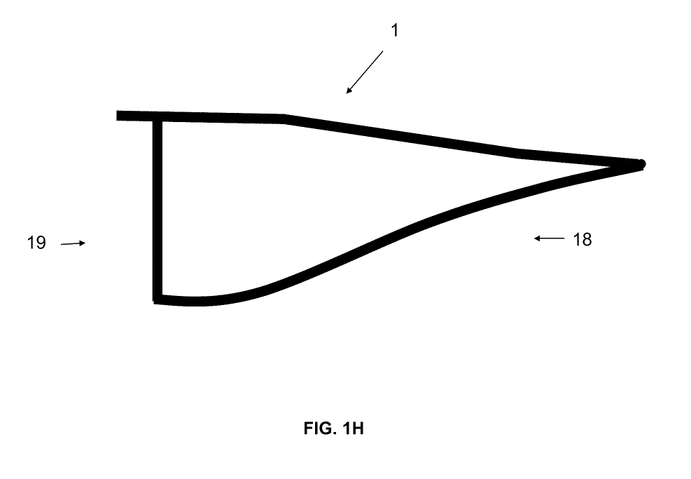

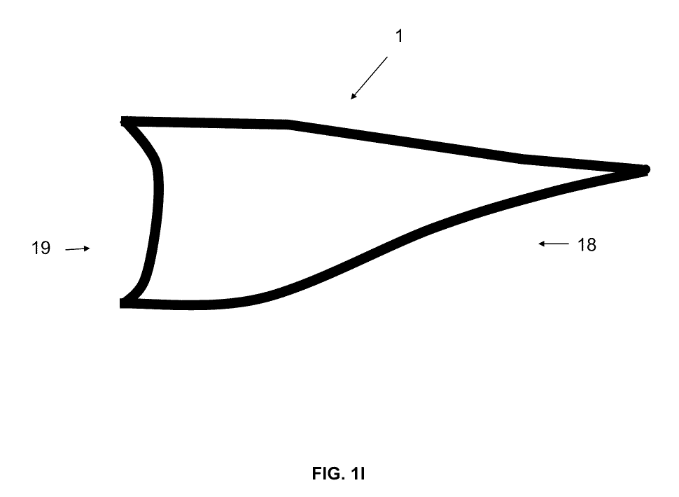

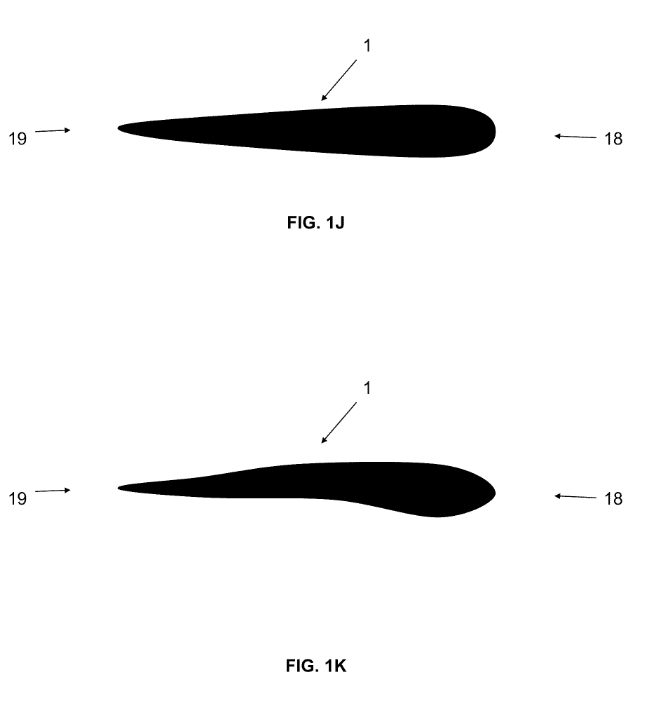

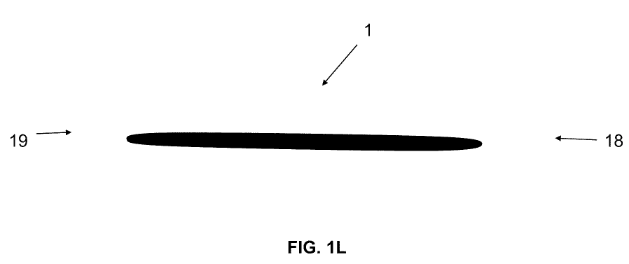

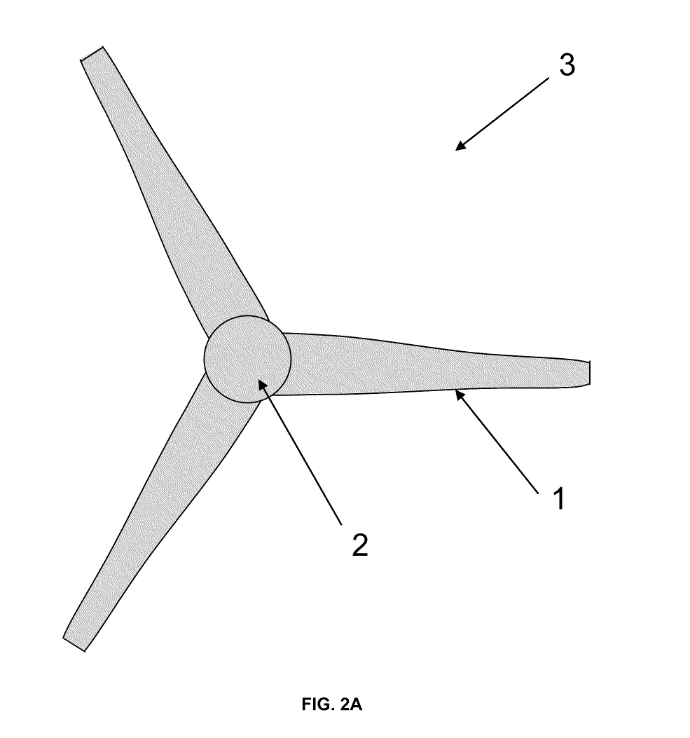

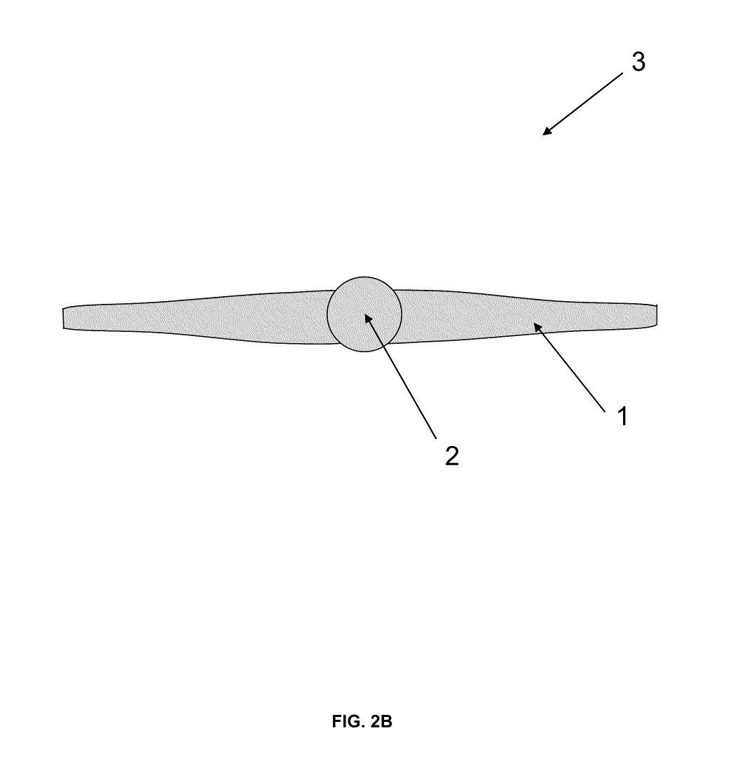

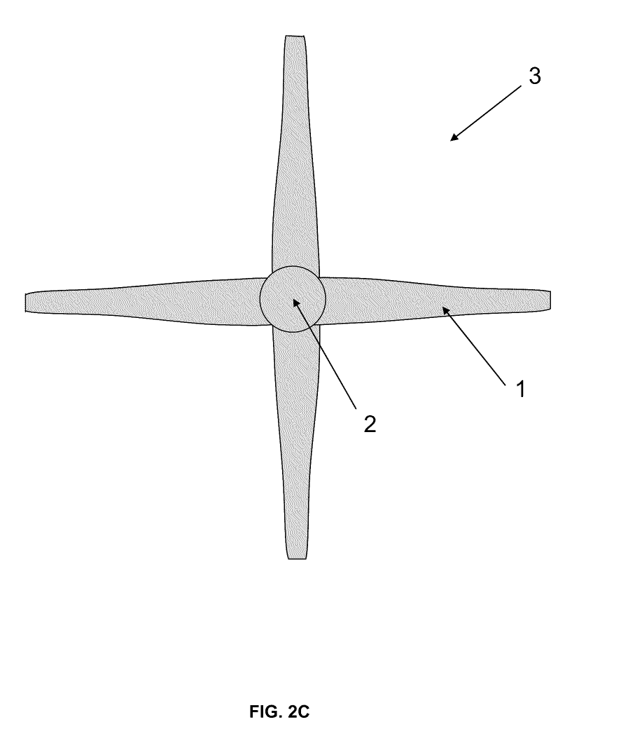

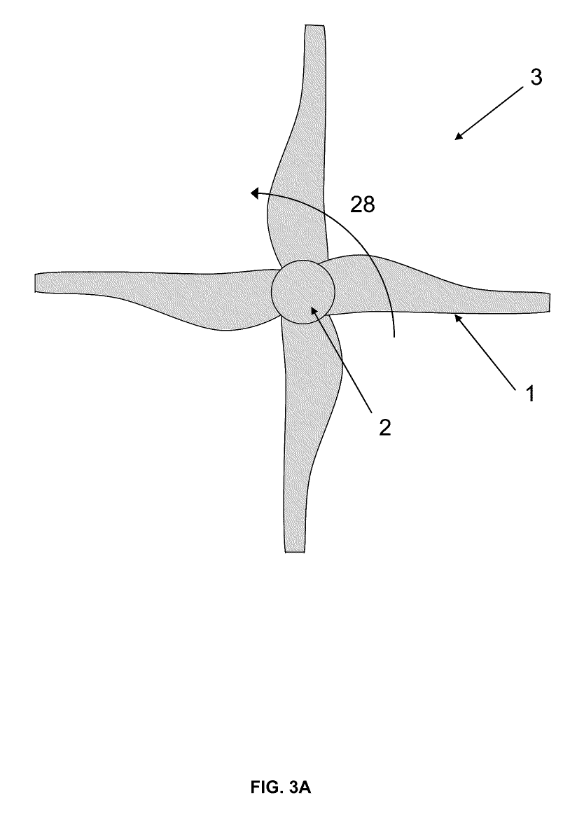

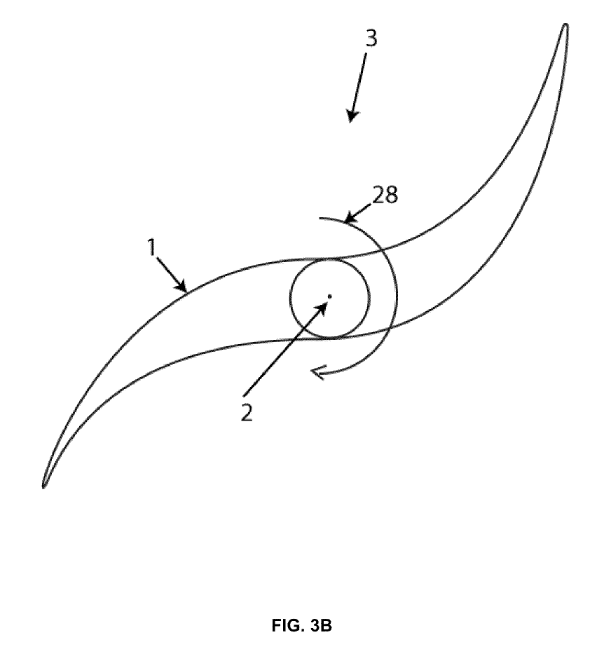

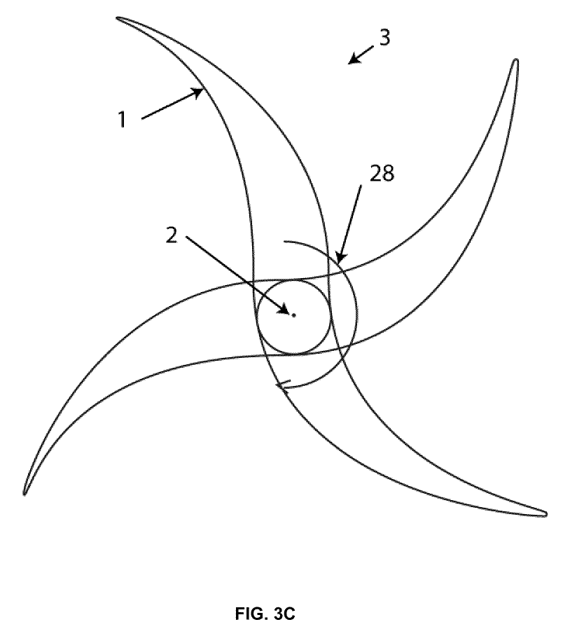

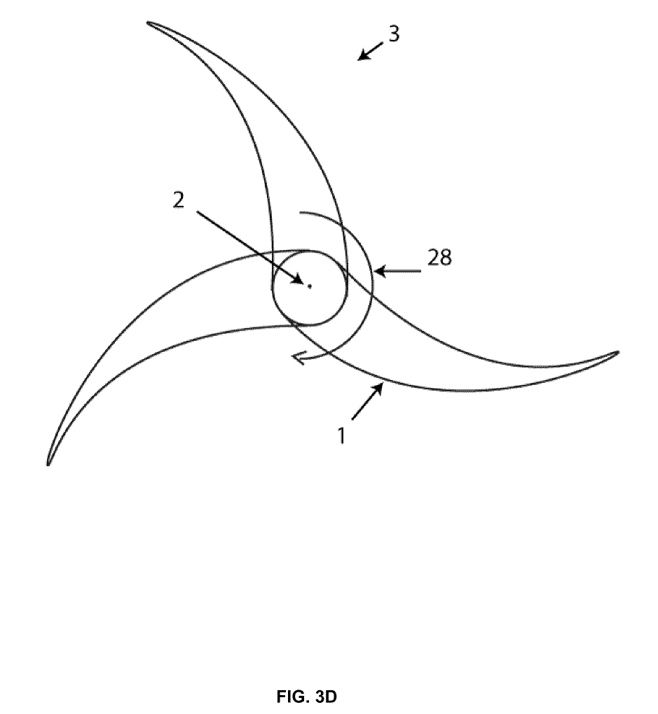

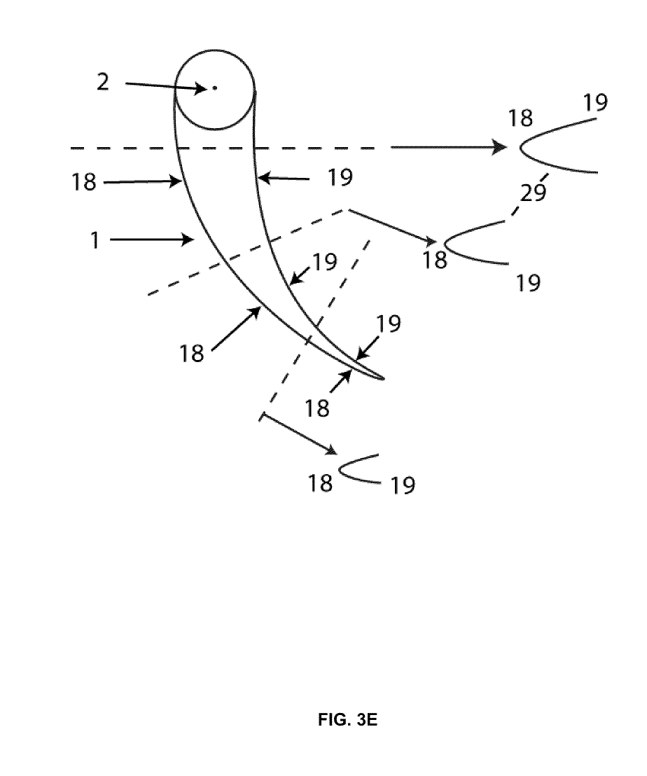

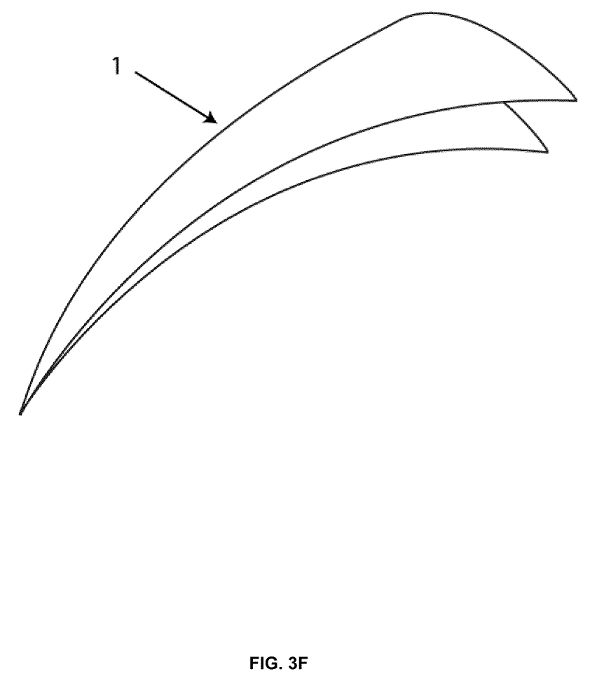

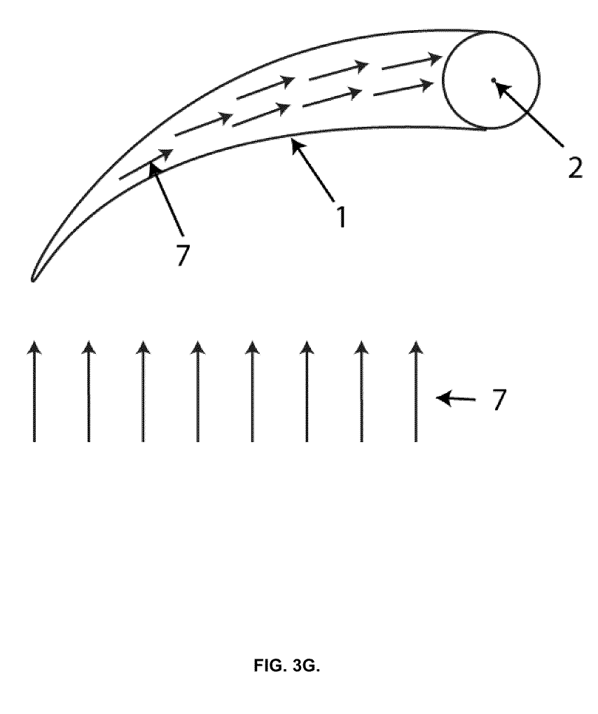

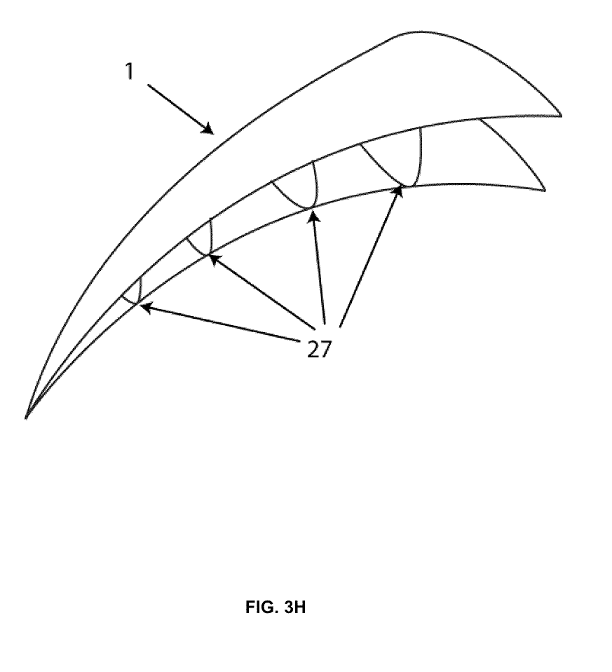

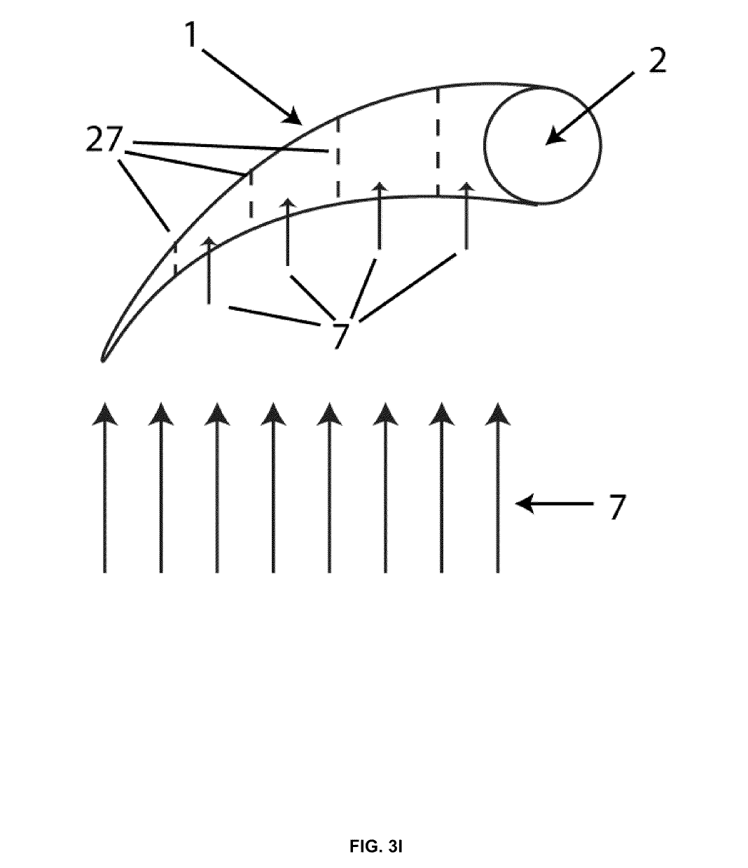

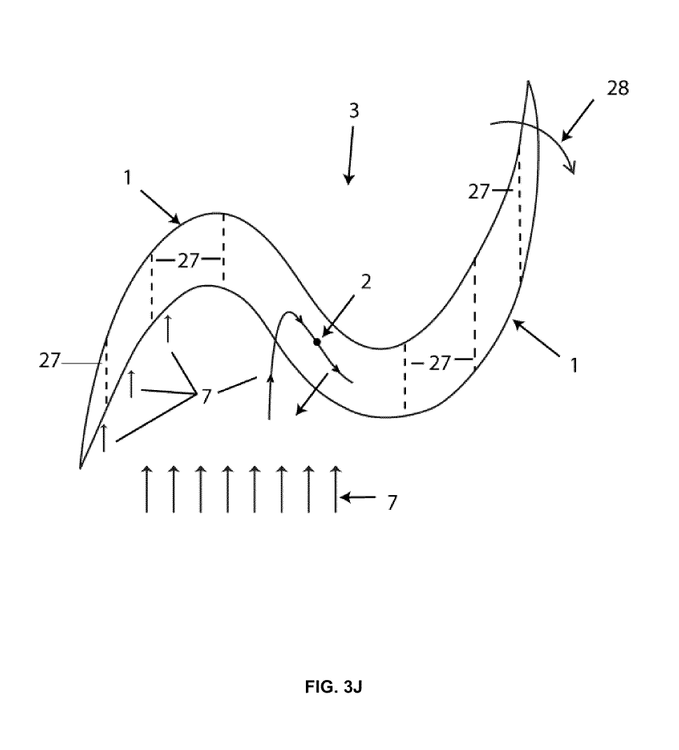

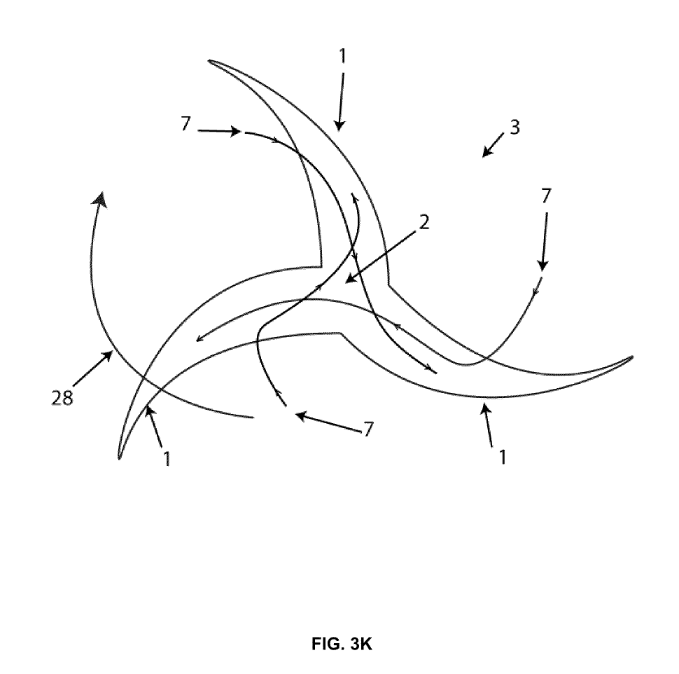

FIGS. 1A-L illustrates one or more aspects of an example rotor blade 1. More specifically, rotor blade 1 is shown in FIGS. 1A-1B (side views), 1C-1E (top views), 1F-1I (cross sectional views of area near rotation axis), and 1J-1L (cross sectional views of area away from rotation axis). FIG. 2A illustrates an embodiment of rotor 3 where three blades 1 are attached to a central axis of rotation 2. Alternate embodiments of the new rotor is shown in FIG. 2B (two blades) and FIG. 2C (four blades). Other embodiments of rotor 3 are shown in FIGS. 3A-3D. From henceforth, we will refer to embodiments of new rotors described in the disclosure as AIVA (Aerodynamically Improved Vertical Axis) rotors. AIVA rotor 3 may have one, two, or more than two arms or blades. We will refer to an arm or blade of an AIVA rotor as AIVA blade 1. Therefore, AIVA rotor 3 may have two or more AIVA blades 1 which are symmetrically and radially attached to the central axis of rotation.

Embodiments of rotor 3 are designed to rotate around central vertical axis 2 (also referred to as central vertical axis), e.g., as defined by a longitudinal support member. In the disclosure, in some case, the radial distance from the central vertical axis 2 may be referred to as “r” and the angular rotation rate of the rotor as “ω”. The overall length of AIVA blade 1 of AIVA rotor 3 will be referred in some cases as “R”. In some examples, the shape of the cross section of AIVA blade 1 varies with the radial distance “r.” For ease of illustration, three zones or sections of the AIVA blade as shown in FIGS. 1A and 1B. Zone A 15 is closest to the rotation axis, Zone C 17 is closest to the r=R end (which may be referred to as the distal end) of the AIVA blade, and Zone B 16 is a transition region between Zone A 15 and Zone C 17.

In Zone A 15, the local speed of the rotor, no, may be less than the wind speed (denoted as “W”). In this zone, the AIVA blade 1, may be designed to capture energy from the wind using a drag mechanism. As shown in FIGS. 1F through 1K, one side of the AIVA blade, which may be referred to as the A-side 18 (or leading edge or leading side), may have a sleek aerodynamic shape with a low drag coefficient, and the other side, which may be reffered to as the B-side 19 (or trailing side or trailing edge), may have high drag coefficient in Zone A in order to capture wind energy. As shown in FIG. 1L, in Zone C 17, the shape of the rotors is more aerodynamic from both A-side 18 and B-side 19. Such a configuration may allow AIVA blades 1 to be used to support other elements, such as vertically placed airfoils, at the distal end of an AIVA blade (at r=R) (or some portion within Zone C) that will move faster than the wind speed W when Rω exceeds W.

When an AIVA blade 1, which may rotate around a vertical axis that is perpendicular to the direction of the wind, is positioned on the side of the vertical rotation axis where the blade 1 rotates in the direction of the wind, the B-side of the AIVA blade in Zone A catches air and generates a force in the direction of movement and when the AIVA blade is positioned on the opposite side of the vertical rotation axis, the A-side of AIVA blade is swept into the wind. In some examples, the A-side of the AIVA blade 1 has a sleek aerodynamic shape to minimize the airflow resistance when this side is swept around into the wind. The B-side of the AIVA blade 1 in Zone A, in contrast, has a high drag area that is effective in capturing wind energy. By maximizing the ability of the B-side of the AIVA blade to capture energy from the wind in Zone A, by minimizing the drag resistance on the A-side of the AIVA blade, and by minimizing the drag resistance on the B-side of the rotor in Zone C where the local speed of the AIVA blade can be faster than the wind speed, the energy that is produced may be increased compared to other VAWTs without AIVA blades 1.

FIGS. 3A-3D illustrate various embodiments of AIVA blades 1 that have curvature which reduces the drag on the A-side while increasing the drag on the B-side. FIG. 3E shows a top view along with three cross sections 29 of an AIVA blade and FIG. 3F shows a 3-D view of the same example blade 1 shown in FIG. 3E. FIG. 3G illustrates how the air will flow through the blade 1. An alternative design of an AIVA blade 1 is shown in FIG. 3H. In FIG. 3H, blade 1 includes blocking walls 27 are used to block airflow along the length of the arms and thereby increase the drag on the B-side of the AIVA blade 1. FIG. 3I illustrates the airflow pattern when blocking walls 27 are used for blade 1, e.g., as shown in FIG. 3H.

An embodiment of an AIVA rotor having two blades 1 configured to rotate about central axis 2 is shown in FIG. 3J. In this case blocking walls 27 are used in the outer sections of the AIVA blades 1, but the inner sections of the blades 1 are designed to allow for airflow from one blade to the other. It will be understood that this is only one embodiment of the invention and other configurations are contemplated. For example, blocking walls could be incorporated. In one embodiment, no blocking walls are used and airflow is unimpeded in passing from one blade to the other, while in another embodiment blocking walls are used to effectively stop any airflow from one blade to the other.

In some examples, rotor blade 1 may extend radially outwardly from the vertical rotational axis along a non-linear path in the rotational plane. In some examples, such as, e.g., rotor blade 1 shown in FIG. 3B-3K, may be curved from the vertical rotational axis 2 toward the outer diameter of the circular path followed by the blades during rotation.

FIG. 3K shows an alternative embodiment of an AIVA rotor with three AIVA blades 1 configured to rotate about central axis 2. In such a configuration, the design of the center part of the rotor is such that airflow is channeled from each blade to the neighboring blade.

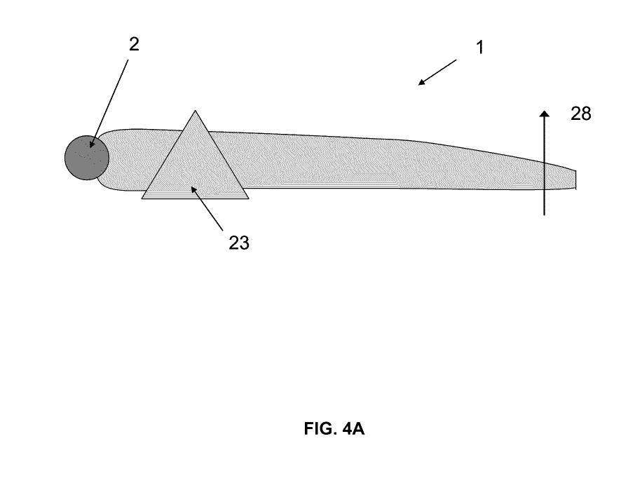

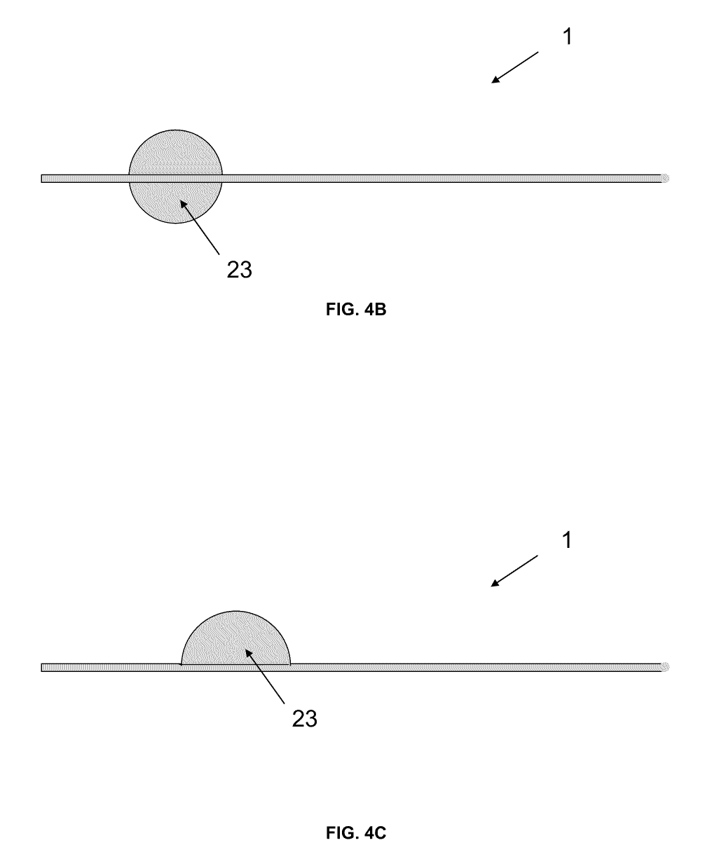

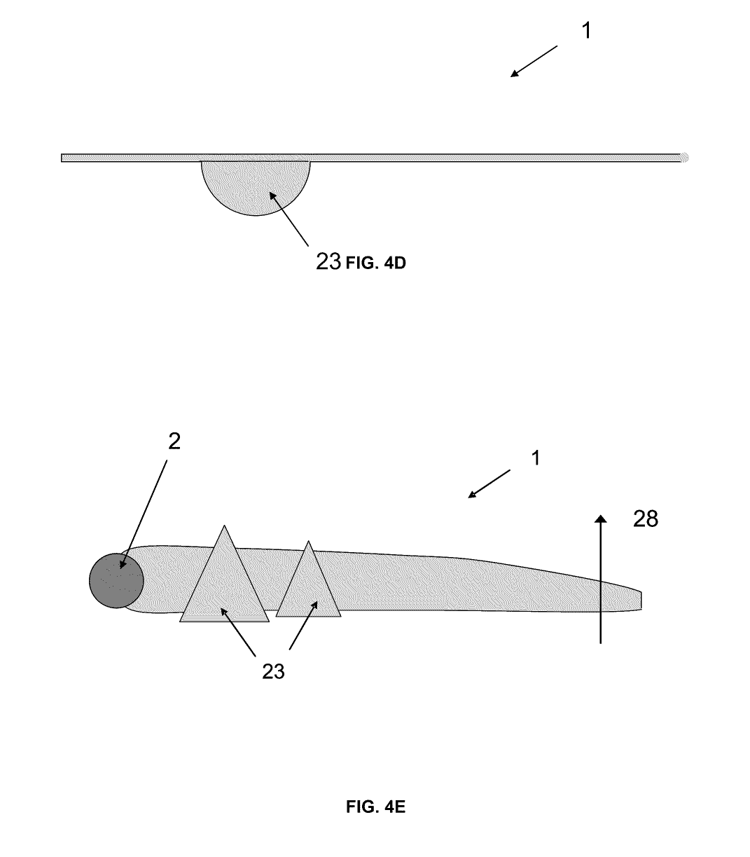

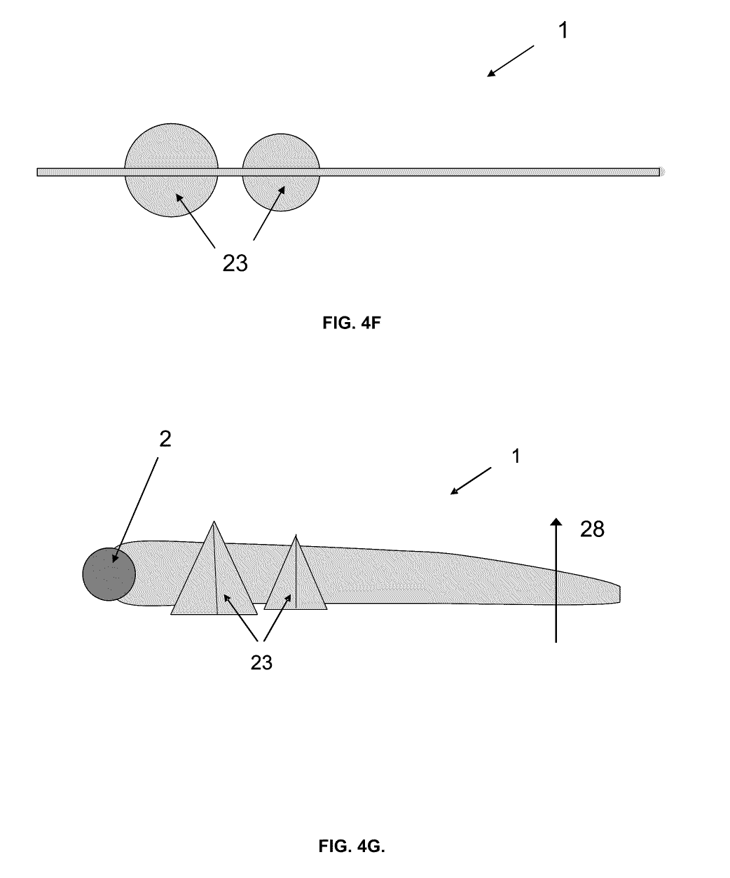

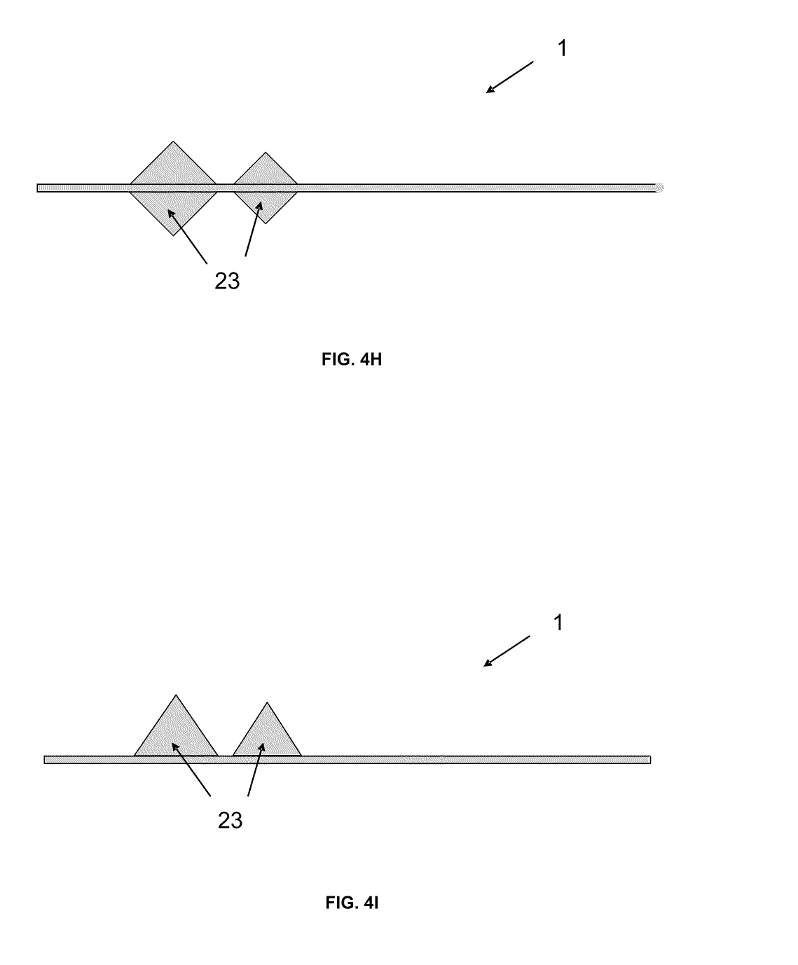

In one embodiment of the disclosure, the cross sectional shape of the AIVA blade in Zone C is that the same or substantially similar to that of an airfoil. In an alternative embodiment the cross sectional shape of the AIVA blade in Zone C is a relatively thin plate with narrow and rounded edges. FIG. 1A illustrates a side view of an embodiment of an AIVA blade. In Zone B, the AIVA blade gradually changes in its cross section from a shape with a high drag B-side in Zone A to an airfoil shape in Zone C. In some embodiments, the length of Zone B is made vanishingly small and the blade abruptly changes from the Zone A to the Zone C shapes. In one embodiment, such an abrupt change may be achieved by using a wind catching structure, such as, e.g., one or more cone-like shapes 23 in Zone A as shown in FIGS. 4A (top view) and 4B (B-side view). Example wind catching structures that may be incorporated into blade 1 are describe in further detail below. In general, a wind catching structure may increase the drag coefficient of blade 1, e.g., at the portion of blade on which the wind catching structure in located. For example, in FIGS. 4A and 4B, cone-like structure 23 may define an opening face defining a plane that is substantially perpendicular to the rotational plane of blade 1 in a manner that increase the drag coefficient at the corresponding portion of blade 1. Alternative embodiments of AIVA blades with cone-like structures 23 are shown in FIGS. 4C-4J. In some embodiments, the length of Zone B is longer and the blade changes more gradually from the Zone A to the Zone C shapes.

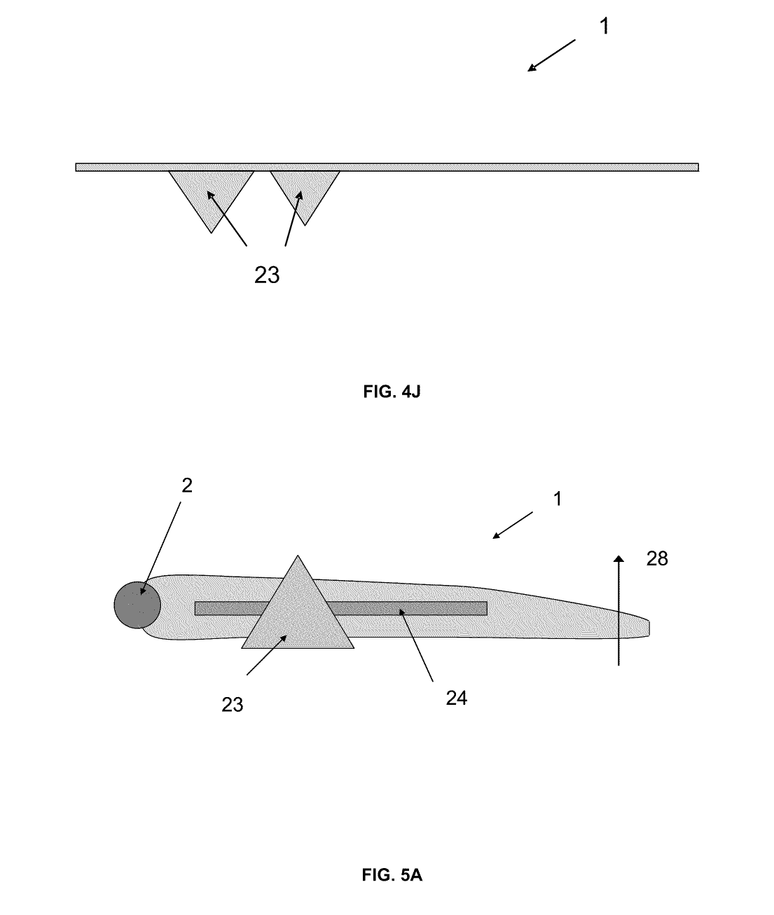

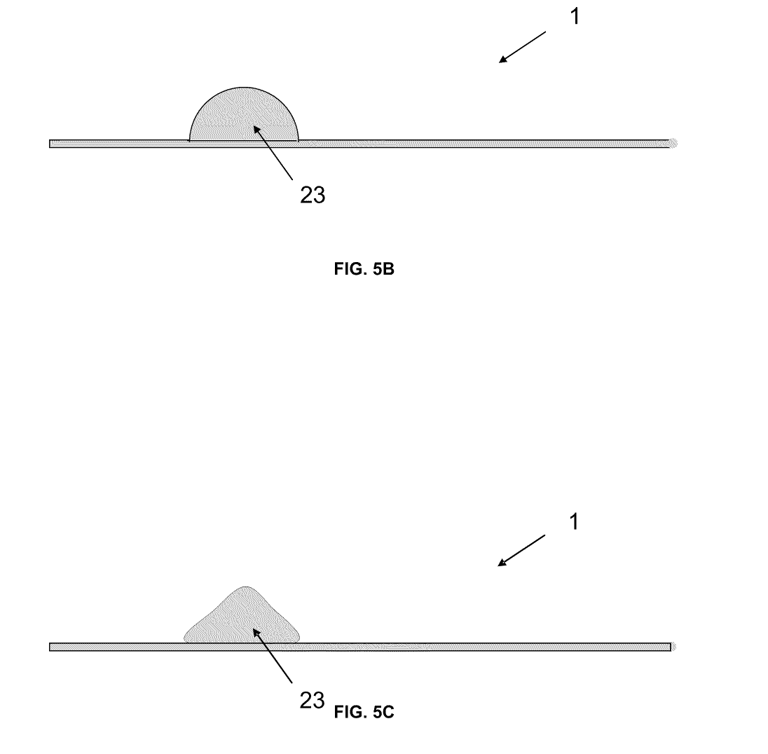

An alternative embodiment using a wind catching structure is shown in FIGS. 5A (top view) and 5B (B-side view). In FIGS. 5A and 5B, the wind catching structure is shown a cone-like structure, although other shapes and designs are contemplated. In FIGS. 5A and 5B, cone-like structure 23 is positioned on rail 24 where the position of the cone-like structure can be translated about the length of blade 1 to generate the optimum performance. An alternative side view is shown in FIG. 5C. In some embodiments, the position of the cone-like structure is changed depending on the wind speed.

The embodiments of the AIVA blades shown in FIGS. 1A-1L, 2A-C, 3A-3K, 4A-4J, and 5A-5C are for illustrative purposes only and other embodiments of the disclosure are possible. For example, the detailed shape of the A-side of the rotor can be modified to optimize the airflow. The embodiment shown in FIG. 3B, for example, includes added curvature in the radial direction in Zone A. This reduces the drag in Zone A for the A-side. For the B-side, the blades can have a hollowed out cup or cone-like shape for increased drag in Zone A. The disclosure contemplates any blade where the A-side of the entire AIVA blade has an aerodynamic shape with low drag coefficient and where in Zone A the B-side has a cross section chosen to give a high drag coefficient so that it is effective in capturing energy from the wind, while both the A-side and the B-side have low drag coefficients in Zone C. In one embodiment, the drag coefficient from the A-side in Zone A is less than about 0.5 while the drag coefficient from the B-side in Zone A is greater than about 1.0. In another embodiment the drag coefficient from the A-side in Zone C is less than about 0.2.

For descriptive purposes, the term thickness may be used to refer to the overall vertical thickness of an AIVA blade (e.g., the thickness of the blade in a direction substantially perpendicular to the rotational place). In one embodiment of the disclosure, AIVA blades 1 have a thickness that varies with radial distance from center shaft 2, e.g., as shown in FIG. 1A. In one embodiment, the thickness of the AIVA blades 1 is relatively large in Zone A so that the AIVA blade can effectively catch wind on the B-side 19 (trailing edge) when moving slowly. The thickness of blade 1 can gradually taper in Zone B 16 to become a thin foil in Zone C 17 in order to reduce drag when the angular speed is high and the local AIVA blade speed 1 in Zone C 17 is greater than the speed of the wind.

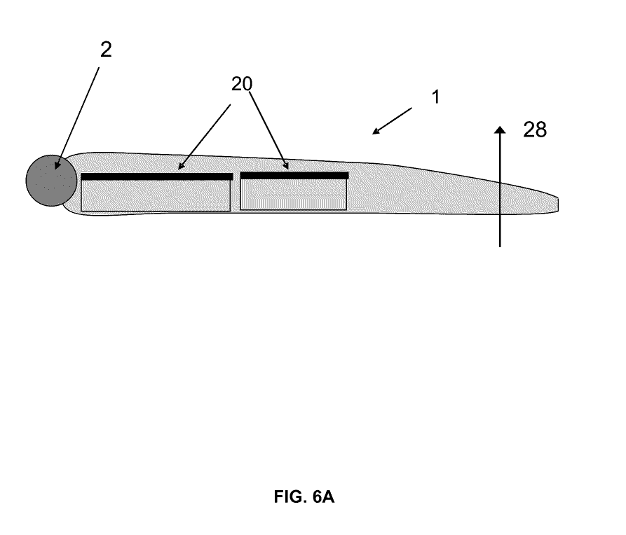

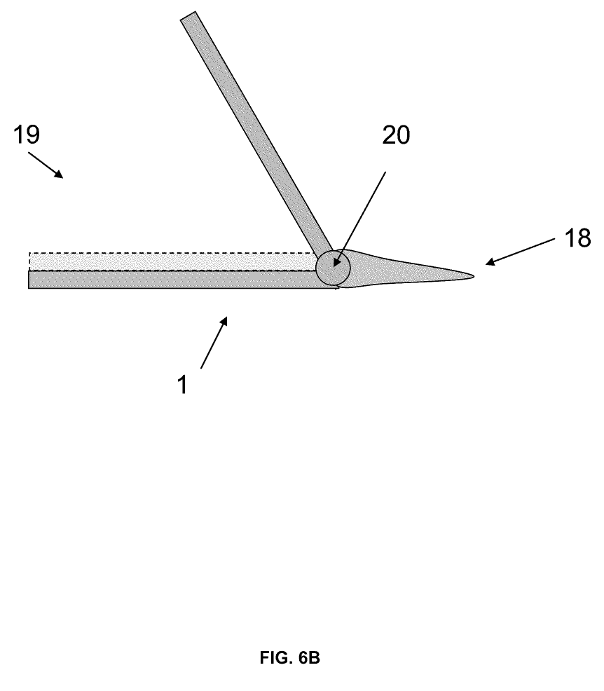

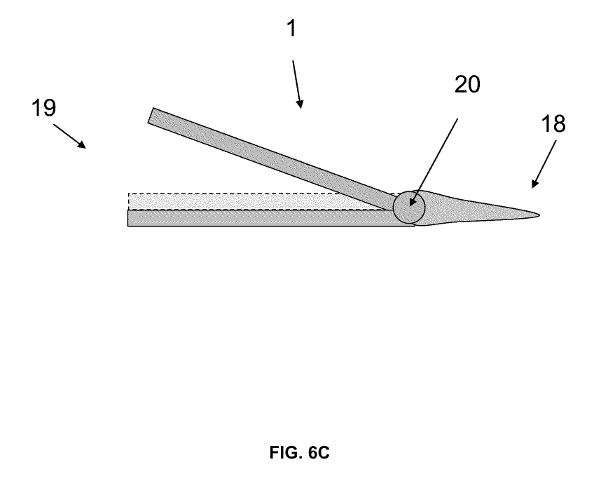

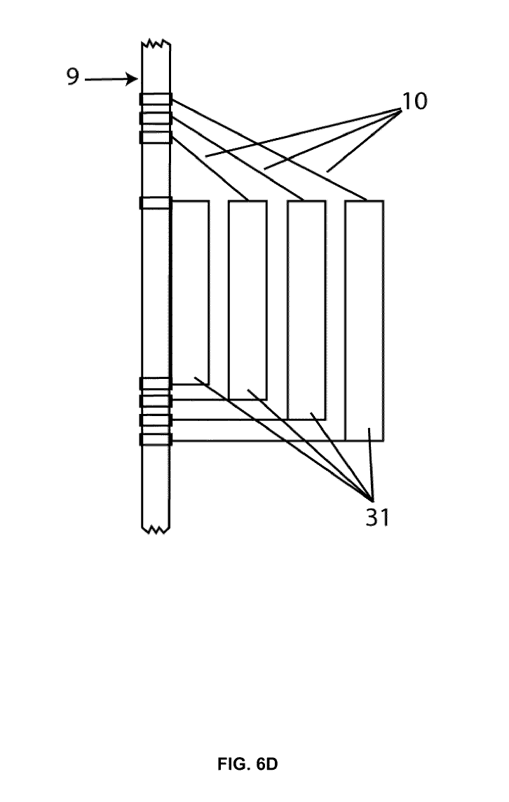

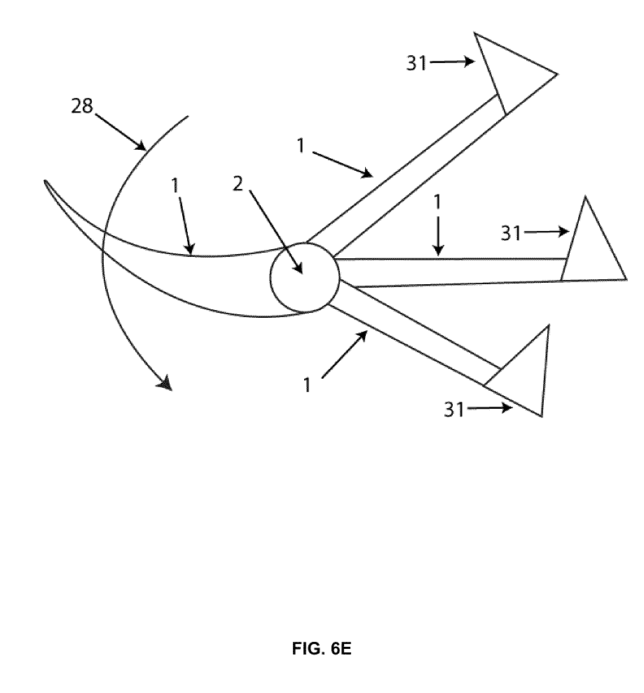

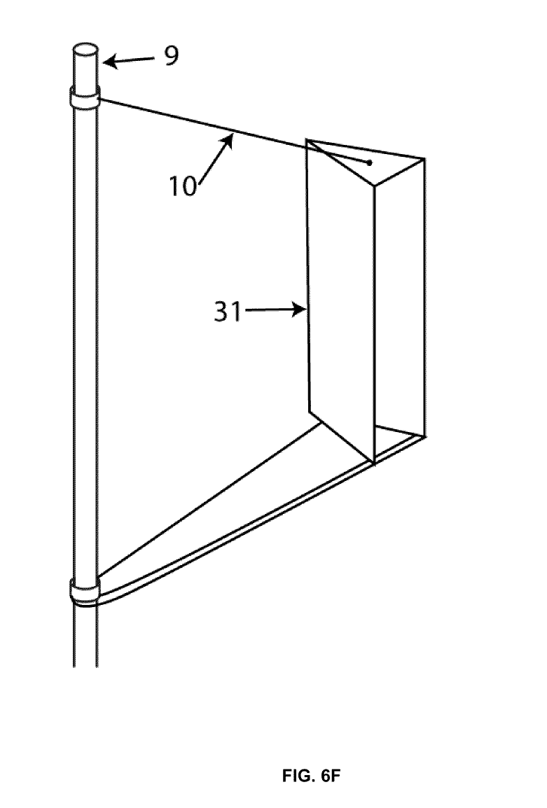

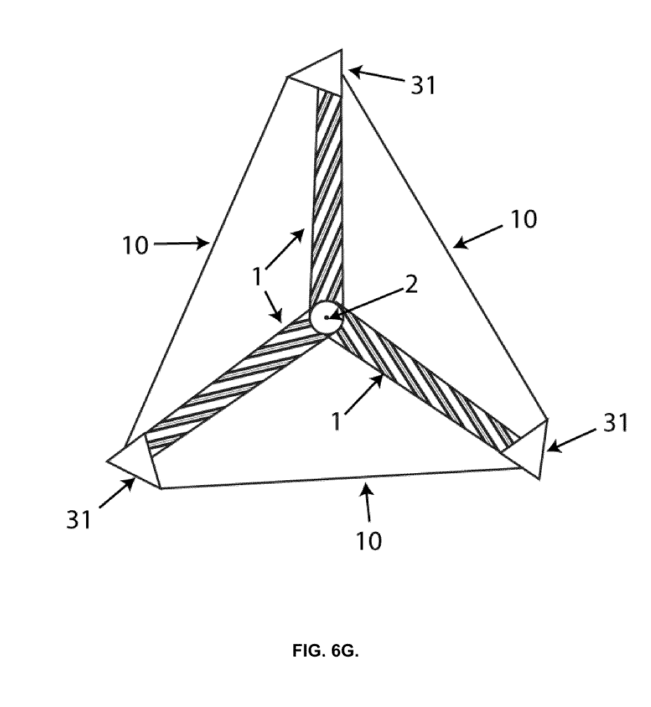

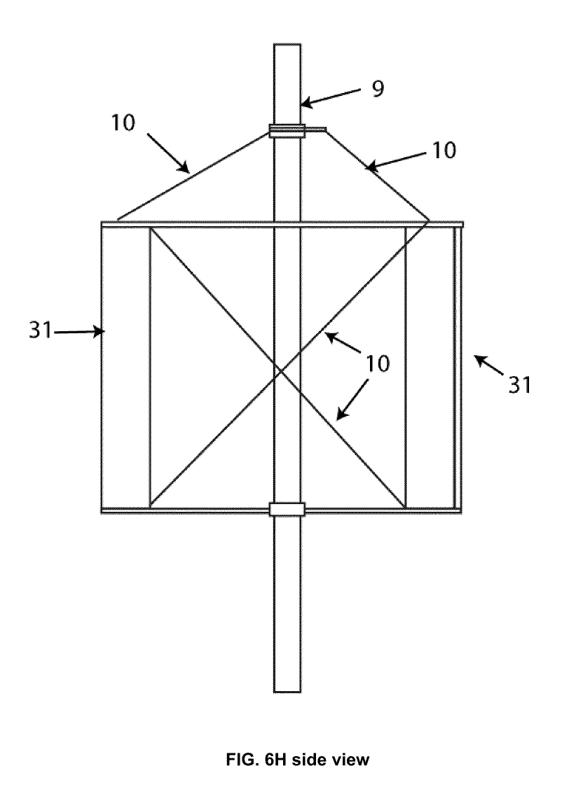

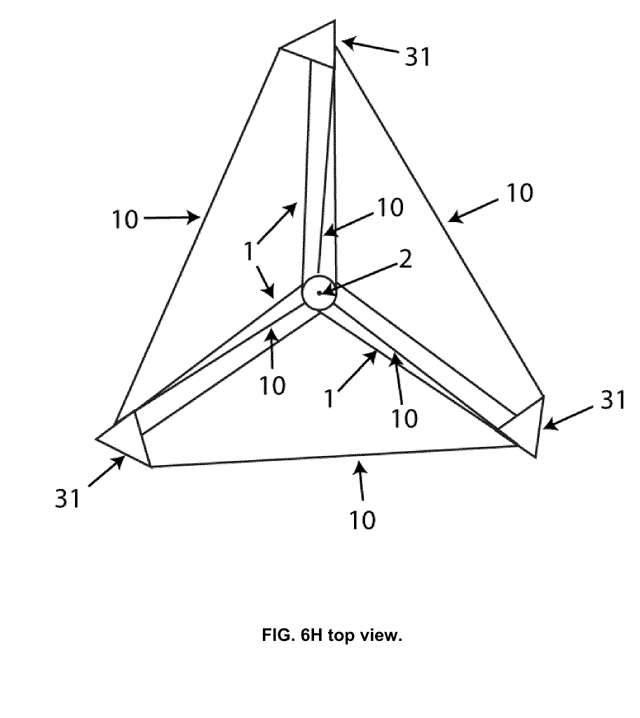

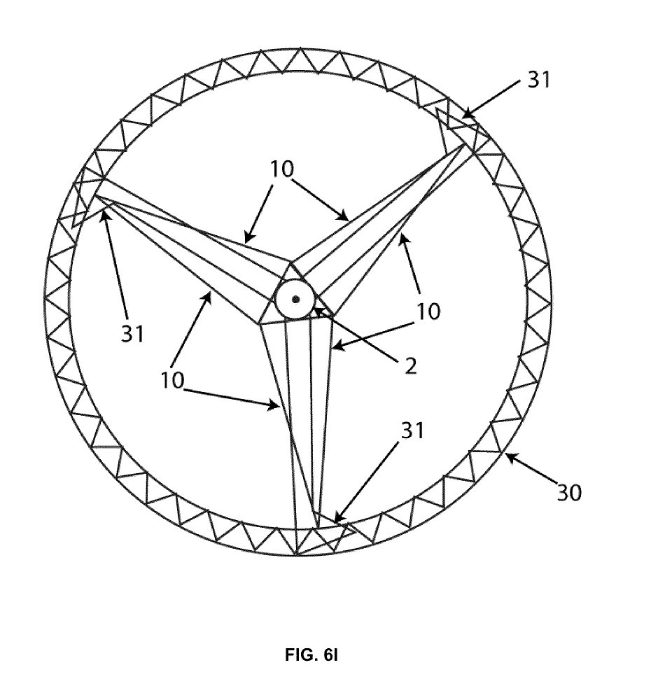

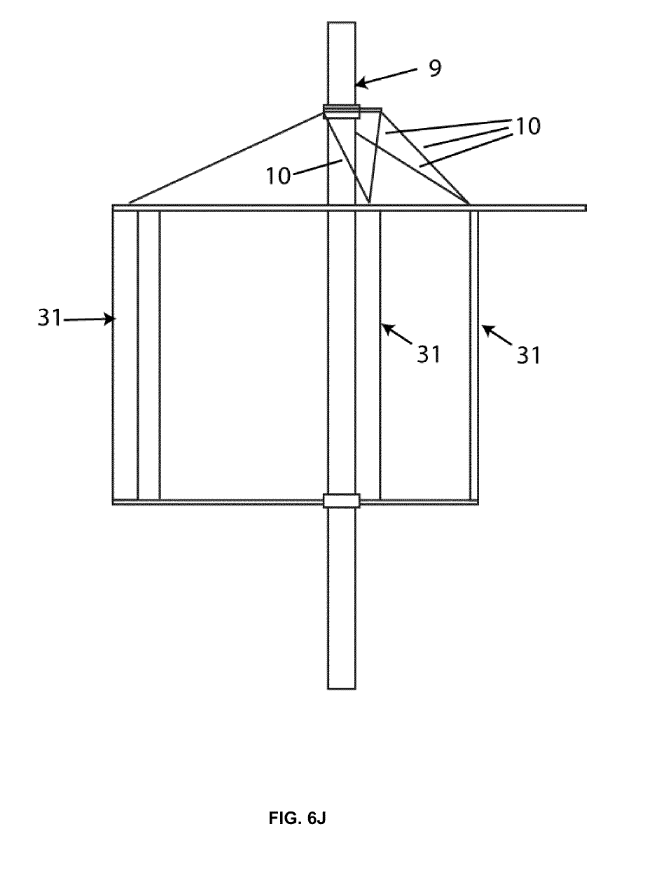

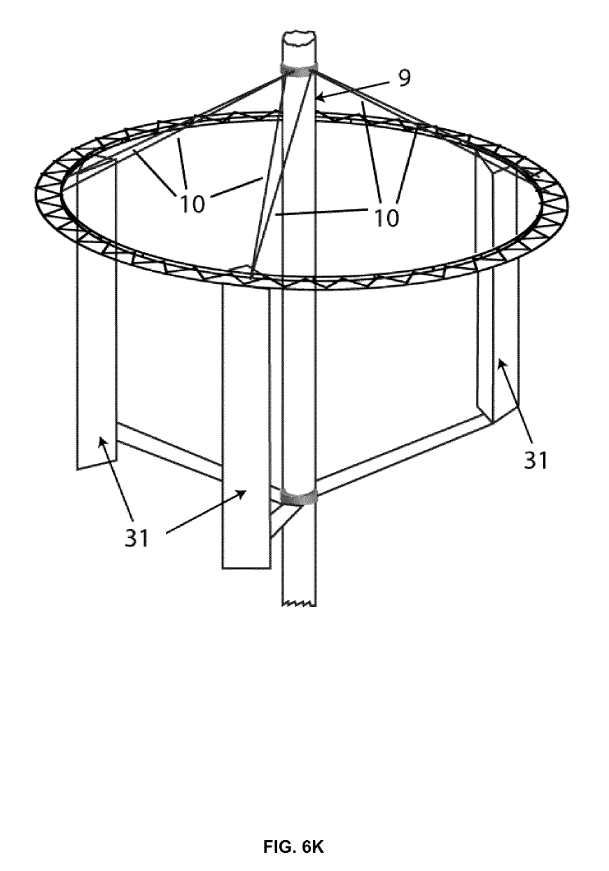

In one embodiment of the disclosure, AIVA blades 1 have a thickness that can be adjusted so that at slow speeds the thickness is adjusted to a maximum value and at higher speeds the thickness is reduced to minimize drag. This thickness variation can be achieved by having adjustable hinge 20 and flap coupled to the surface of blade 1 that defines an angle at the front of the AIVA blade. When this angle is large the AIVA blade has more cross sectional area available to catch wind and when the angle is low the AIVA blade has a sleek aerodynamic shape. An example of such a configuration is illustrated in FIGS. 6A-6C. A top view is shown in FIG. 6A. In FIG. 6B, the angle of the flap with respect to blade 1 is high for effectively catching wind and in FIG. 6C the angle is low and provides lower drag. Multiple hinges 20 can be used to create multiple heights across the length of the blade. In one embodiment, two groups of hinges are used in each zone for a total of six independently adjustable angles. In some examples, flap and hinge components may be utilized as wind catching structure, e.g., as described above.

In some embodiment, AIVA blade 1 can be partly hollow in order to minimize the weight. Additional weight reductions can be obtained by choosing the construction materials for the rotors from advanced composites. The AIVA blades can be further stabilized by using cables, e.g., guy wires, from hubs located above the level of the rotor. The use of the cables allow for a reduced weigh to the AIVA blades since the shaft of the AIVA blades would not need to support its full weight. Another property of some embodiments of the AIVA blades is that their geometry can be chosen so that they generate lift due to the flow pattern of air above and below the AIVA blades. This will reduce stress on the AIVA blades and AIVA rotor (an assembly of AIVA blades which is a unit which rotates around an axis) and any supporting cables during normal operation which in turn translates into a longer lifetime for the rotor. An AIVA rotor can consist of one, two or more than two AIVA blades which are radially and symmetrically attached to the axis of rotation of the AIVA rotor. All AIVA blades in an AIVA rotor rotate under the influence of torque produced by wind as components of a single structure. This single structure may be referred to as an AIVA rotor.

An alternative design concept for AIVA rotors is the Concentric Multiple Vertical Rotors (CMVR) concept. An example of a CMVR rotor is shown in FIG. 6D. Here, instead of using a single wide rotor arm, several narrower horizontally oriented rotor blades are used to span the same space. In some examples, an airfoil can be place or another wind catching structure 31, as shown, e.g., in FIGS. 6D-6K, can be placed at a distal portion of the rotor blades. The advantage to this is that each of the narrower blades can rotate independently of each other. This allows for different angular rotation rates for each of the narrow blades so that the speed of each arm, which is given by the angular rotation rate times the radial position, can be kept at the optimum speed relative to the wind speed. In contrast to the CMVR case, a single large rotor blade rotating at any given angular rotation rate would have sections moving at different speeds and so only a narrow strip of the rotor would have the optimum speed relative to the wind. The CMVR concept solves this problem by allowing for multiple angular rotation rates and thus an improved efficiency. A top view of an AIVA rotor utilizing three arms in a CMVR configuration is shown in FIG. 6E and a bird's eye view of an individual arm is shown in FIG. 6F.

In order to increase the structural stability of a CMVR design, guy wires can be used to connect adjacent rotor blades together as shown in FIG. 6G. Alternate views are shown in FIG. 6H. For clarity, the blades are shown at only one radial position, however, the blades at other radial positions can also be stabilized using the guy wire construction. Guy wires can be used in the plane of the rotors and/or vertically to help support the weight. FIG. 6I shows a top view of an AIVA rotor where a ring-like structure is used to support vertical rotors and guy wires connect the ring-like structure to a triangular shaped head located above the ring-like structure. A side view of this embodiment of the invention is shown in FIG. 6J and a bird's eye view is shown in FIG. 6K.

In some embodiments, rotor blades may be coupled to vertically extending wind catching structures 31. In FIG. 6F, for example, a triangular shaped, vertically extending structure 31 is located at a distal portion of the rotor blade 3. In some examples, the triangular shaped, vertically extending structure in FIG. 6F defines an opening face defining a plane that is substantially perpendicular to the rotational place of blade 1. Such a configuration may “catch” the wind when the opening is facing the wind direction and “cut through” the wind when the opening is facing the same direction as the wind direction. Other vertical structure shapes are contemplated. For example, the vertically extending structure may comprises a concave shaped structure. In some examples, a vertically orientated airfoil may be additionally or alternatively coupled to blade 1.

A wind turbine that uses one or more AIVA rotors may be referred to herein as an AIVA turbine. An AIVA turbine may be a self-standing system which incorporates a variety of combinations of AIVA rotors and optional vertical airfoils for the purpose of efficient harnessing of wind energy into the AIVA turbine for generation of electricity.

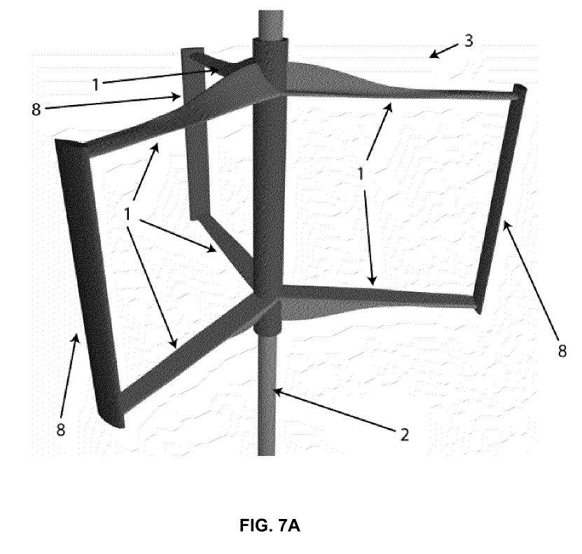

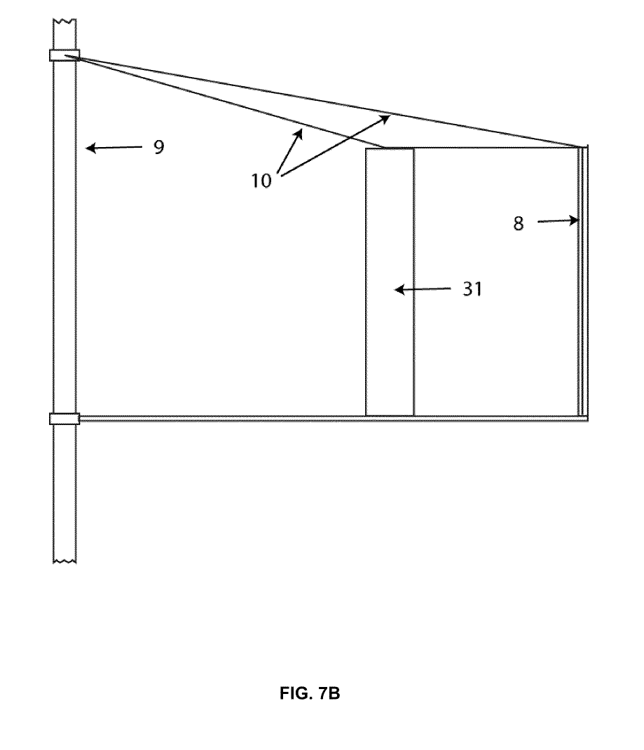

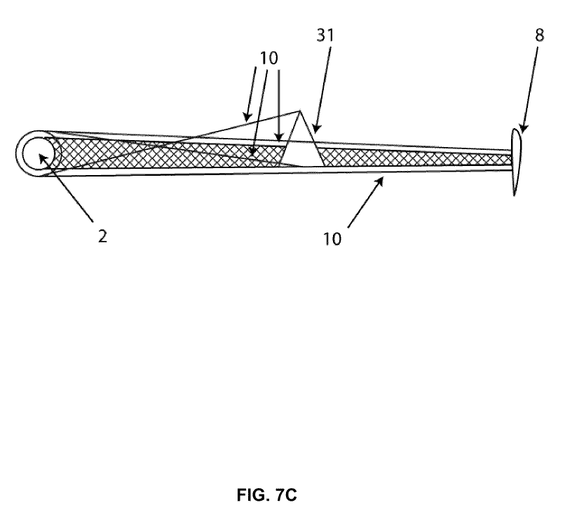

In some H-rotor designs, the arms that support the rotors contribute to drag as the rotor moves. One feature of some embodiments of the present disclosure is that blades, which we call AIVA blades, are disclosed (which may be coupled to vertically airfoils) contribute to torque in the direction of the rotation rather than slow down the rotation. FIG. 7A shows an embodiment of the invention where AIVA blades 1 of AIVA rotor 3 are used to support vertical airfoils 8 in an H-style rotor configuration. This type of turbine offers the improved properties of AIVA rotors 3 with high efficiency of vertical airfoils 8. In alternative embodiments of the AIVA turbine, one, two, or more AIVA rotors are used to support the vertical airfoils. One AIVA rotor 3 can be positioned at the top airfoils 8 and another AIVA rotor 3 can be positioned at the bottom of same airfoils 8. In one embodiment AIVA blades 1 of AIVA rotor 3 can be positioned just outside the area spanned by the airfoils. Because of this, the AIVA rotor blades do not take away any wind energy from the airfoils. In one embodiment, two vertical airfoils are used. In another embodiment, three vertical airfoils are used. In another embodiment four or more vertical airfoils are used. In yet another embodiment, a single vertical airfoil is used with a counter weight for balance.

H-rotors can also be used in connection with CMVR designs by adding an extension arm at the end of the outermost rotor blade and using this to support a vertical airfoil. This is shown in FIG. 7B where only the outermost rotor arm is shown for simplicity. FIG. 7C shows a top view of the rotor blade.

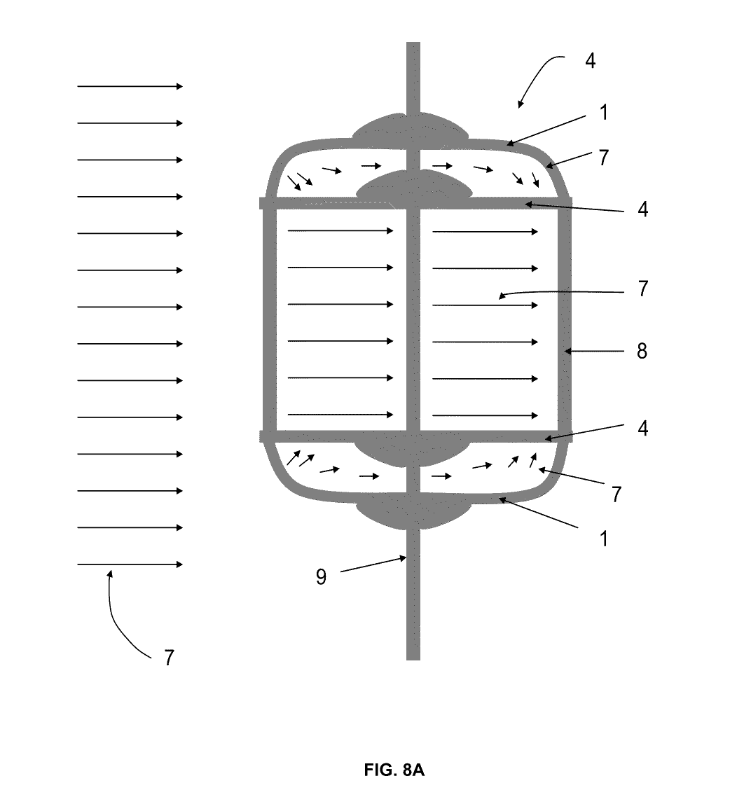

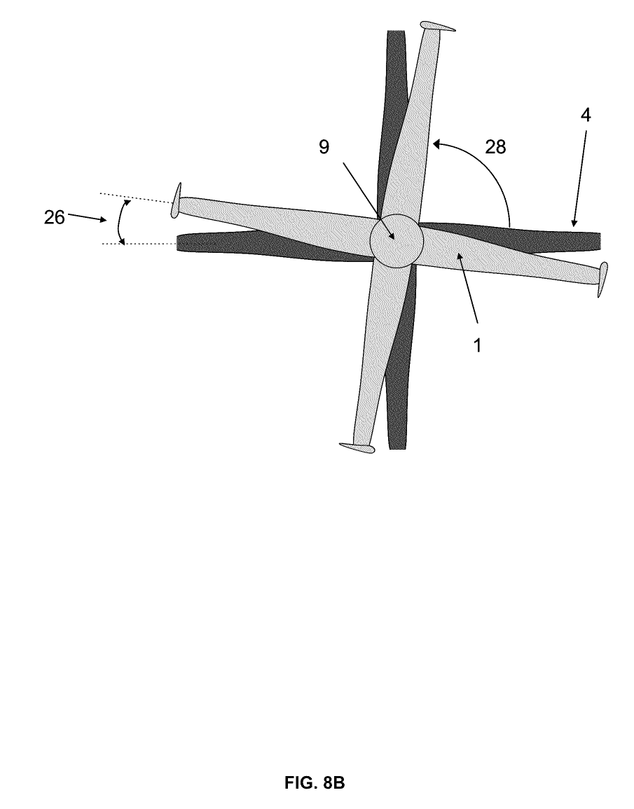

When AIVA rotors are used to support vertical airfoils, the Zone C section of the rotor blades will create drag since this section of the rotor may be moving faster than the wind speed. Some of the energy in the airflow associated with this drag can be recovered in the following way. As shown in FIG. 8A, a curved edge can be used to connect the end of AIVA blade 1 to a vertical airfoil 8. A second rotor 4 including a second set of AIVA blades 1 can be placed under the top AIVA rotor. In a similar fashion, for the bottom set of rotors shown in FIG. 8A, another rotor 4 may be positioned above the bottom AIVA rotor 1. The shape in Zone C of the blades for the second rotor 4 can be chosen to be airfoil shapes. Since the curved edge of the top and bottom AIVA rotors 1 will generate some vertical airflow 7 across the airfoil shaped sections of the second set of rotors 4, additional torque is created that contributes to energy production. The second set rotors 4 can be angularly offset from the first set rotors in order to maximize the benefits of the vertical airflow 7. This can be seen in FIG. 8B where the second set of rotors 4 (the two inner rotors shown in FIG. 8A) is offset by angle 26 from the AIVA rotor 1 (the outer two rotors shown in FIG. 8A). Angle 26 may be adjusted to give the optimum performance. In the embodiment shown in FIG. 8B, the top set of AIVA rotors 1 are not connected to the second set of AIVA rotors 4, however, in other embodiments the top AIVA rotors 1 are bent over near the edges to connect with secondary rotors 4.

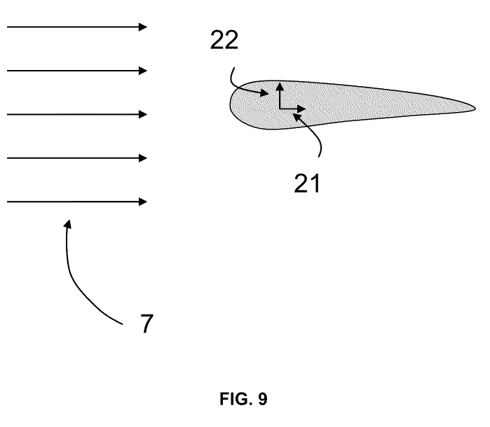

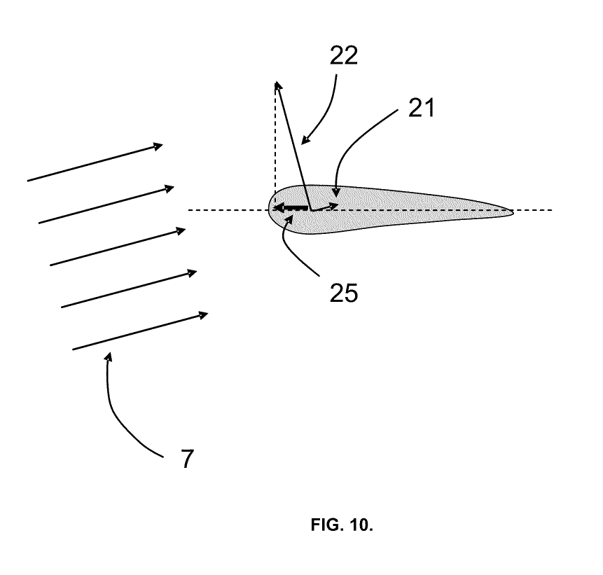

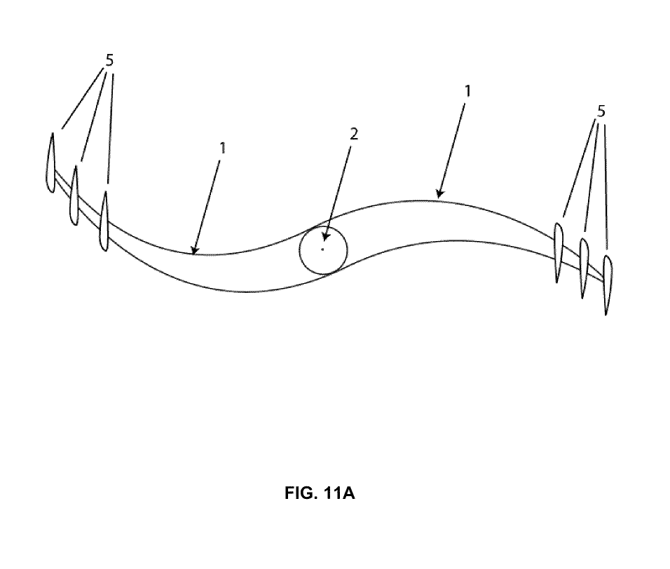

In order to understand how additional torque is generated by vertical airflow from the first set of AIVA blades 1 to second set 2, consider an airfoil rotating along a vertical axis. If there is no vertical component to the wind velocity, the velocity of air relative to the airfoil will be along the axis of the airfoil. This means that there is a zero angle of attack which means that for symmetric airfoils there will be no lift 22, only drag 21. For non-symmetric airfoils, there can be lift 22, but the direction of this force is perpendicular to the motion of the AIVA blade, and therefore does not contribute to the torque. This is illustrated in FIG. 9. Now say that there is some vertical component to the velocity of the air impacting the rotating airfoil. The velocity of air relative to the airfoil now has a component in the vertical direction as illustrated in FIG. 10. This means that there is a non-zero angle of attack and therefore lift 22 is generated. This lift 22 is perpendicular to the relative air velocity and will therefore have component 25 in the direction of motion of the airfoil. Hence, the lift generates a torque in the rotation direction which adds to energy production. Now consider having a top AIVA rotor blade 1 with curved blade edges, e.g., as in FIG. 8 and a second AIVA rotor 4 with an airfoil shaped blades in zone 3. The airfoil shapes in Zone C of the second AIVA rotor 4 will experience a vertical component to the relative air velocity that is created by the first AIVA rotor 1. As we just discussed, this yields a non-zero angle of attack which generates a positive torque on the AIVA rotor.

For an AIVA turbine incorporating AIVA rotors with airfoils the thickness of the AIVA blades of an AIVA rotor can be chosen to vary rapidly with radial distance so that if the vertical airfoils have an optimum tip speed ratio of λ and if the AIVA blades have a length R, Zone A of the AIVA blade extends to about R/λ and then rapidly taper down in Zone B to a thin airfoil. In this way the AIVA blades would have large thickness only in the areas where they can contribute positively to the net torque when the vertical airfoils are moving at the optimum speed relative to the wind speed. In one embodiment this is achieved by a single triangular cone-like structure on each AIVA blade with a width of about R/λ located near the rotation axis. In another embodiment, the cone-like structure is moveable to achieve the most efficient performance. In other embodiments, multiple cone-like structures are used. For example, in one embodiment this is achieved by using a first cone with a width of about (1−α)R/λ near the rotation axis of each AIVA rotor arm and a second cone with a width of about αR/λ adjacent to the first cone. Here α is any number between 0 and 1 and the two cones have a total combined width of R/λ. An embodiment with two cone-like structures is illustrated in FIG. 4.

The position of a cone or cones on an AIVA blade can be moved to the optimum position for best aerodynamic torque on the AIVA rotor. An embodiment of an AIVA blade with an adjustable cone position is shown in FIG. 5. In this embodiment, the cone position can be placed at a large radius during low wind conditions in order to generate more torque, and the cone position can be moved inward during higher wind conditions when the angular rotation rate is higher. This allows for optimum energy generation by the drag mechanism on the AIVA rotors during low wind conditions and optimum energy generation by the lift mechanism on attached vertical airfoils during higher wind conditions.

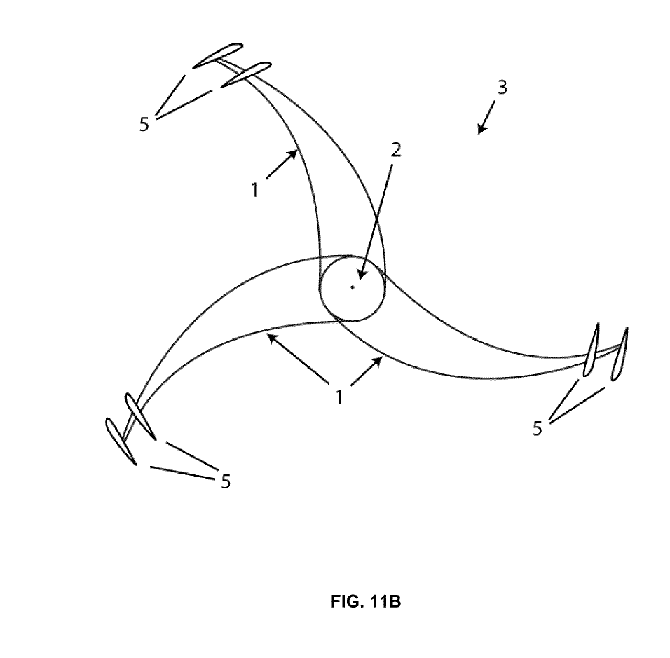

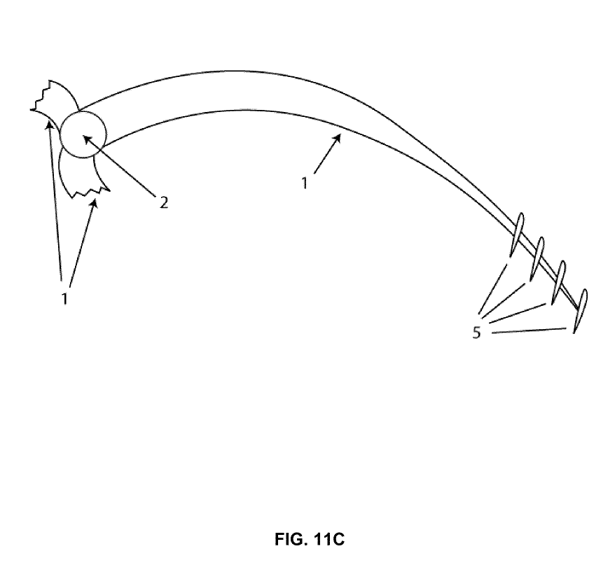

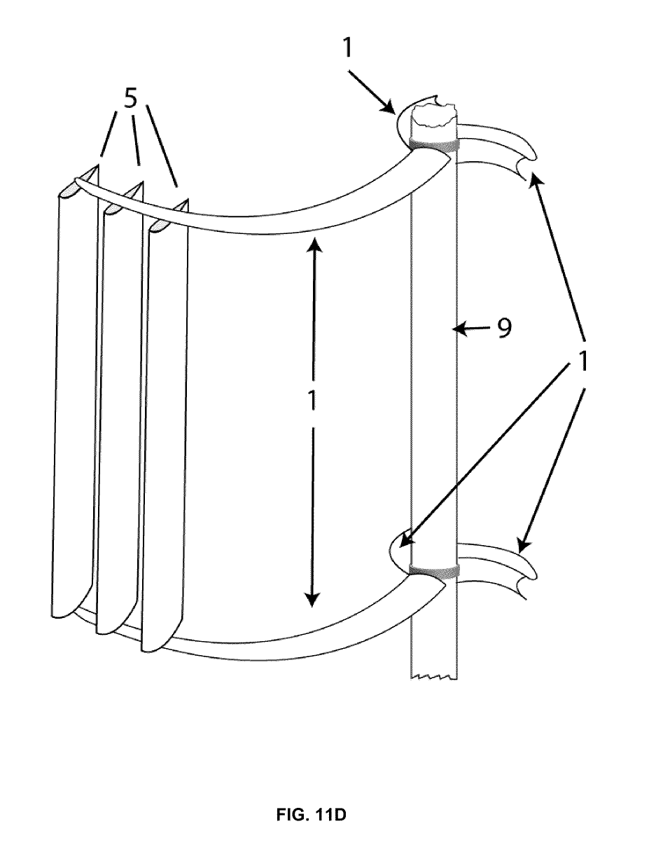

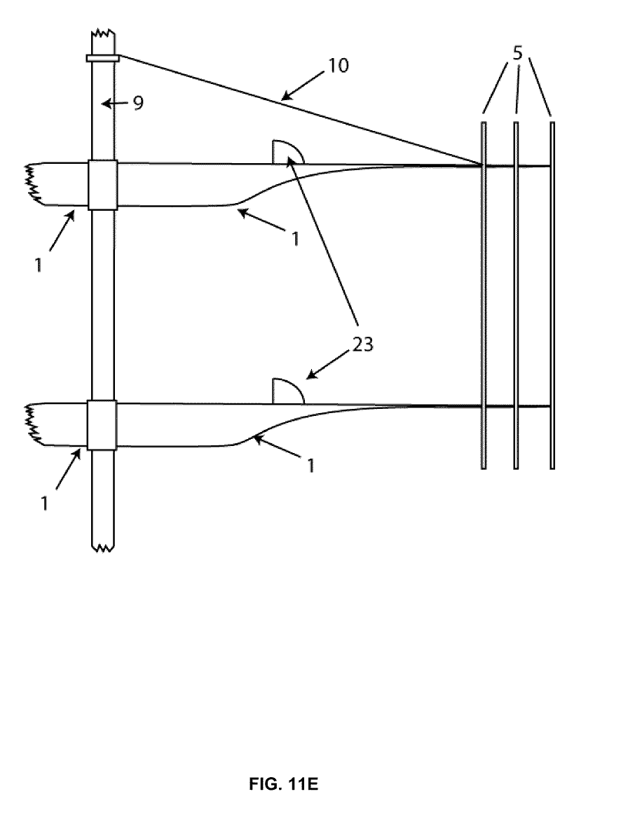

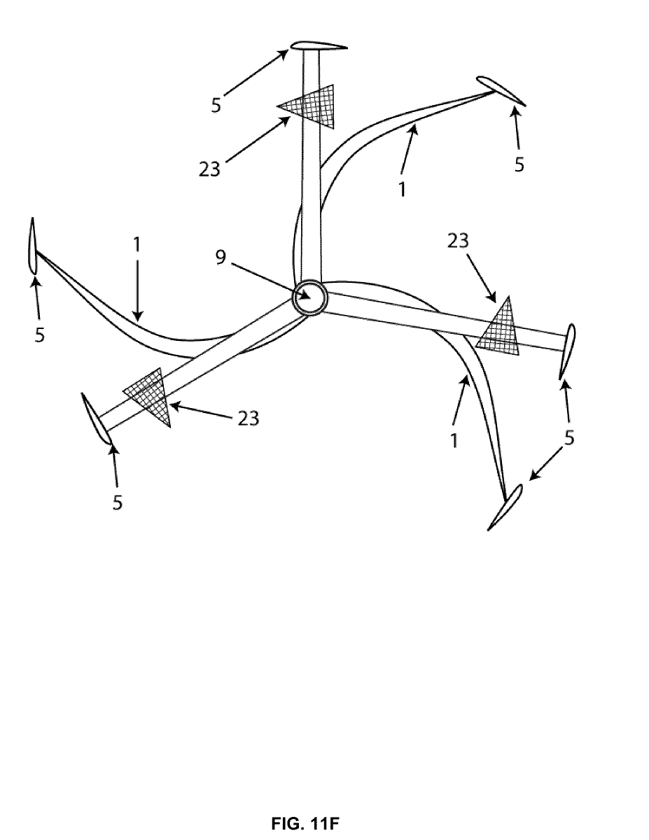

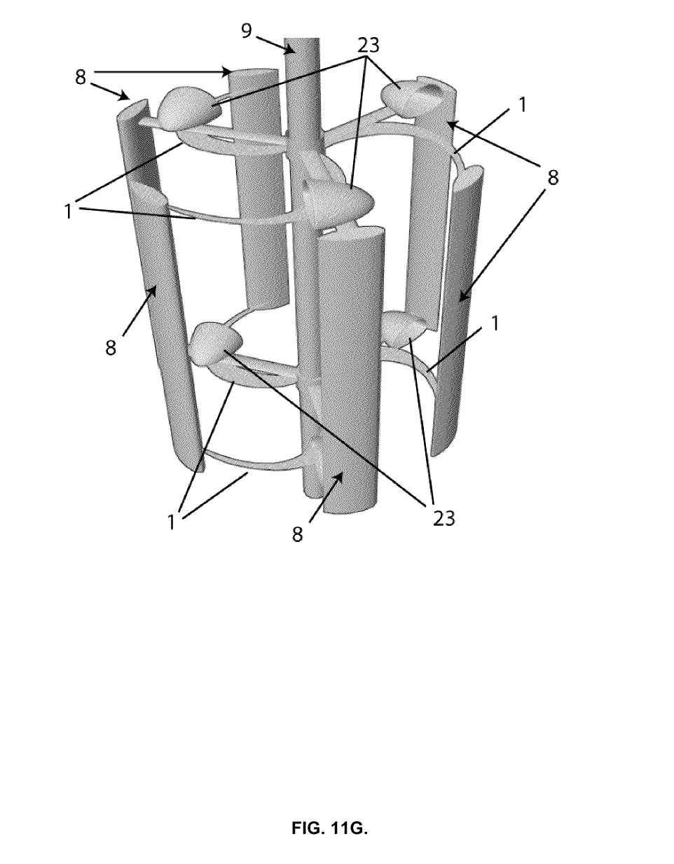

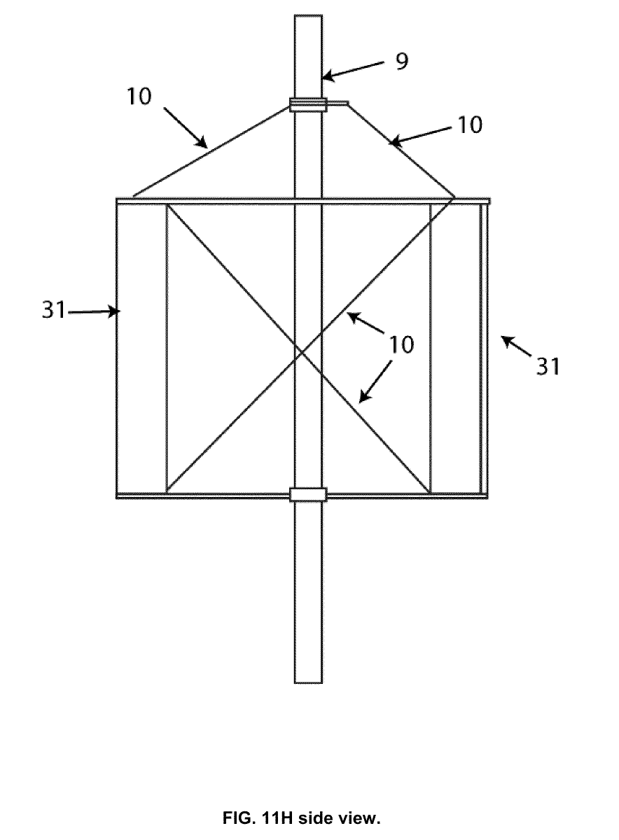

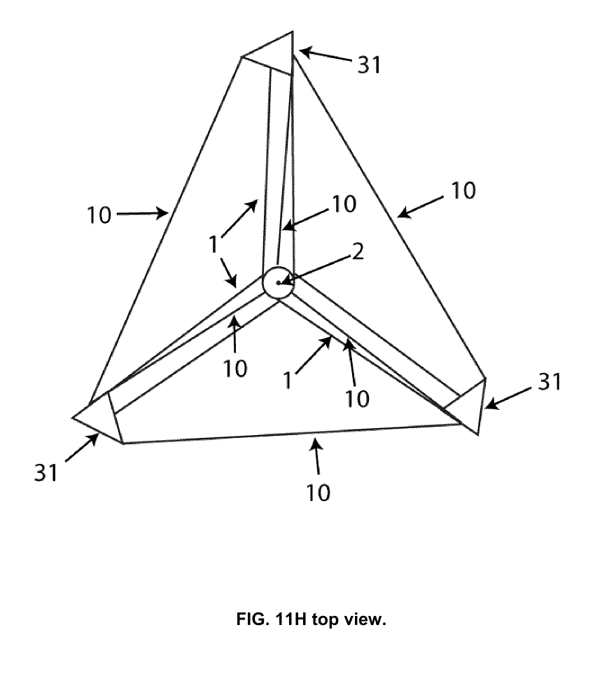

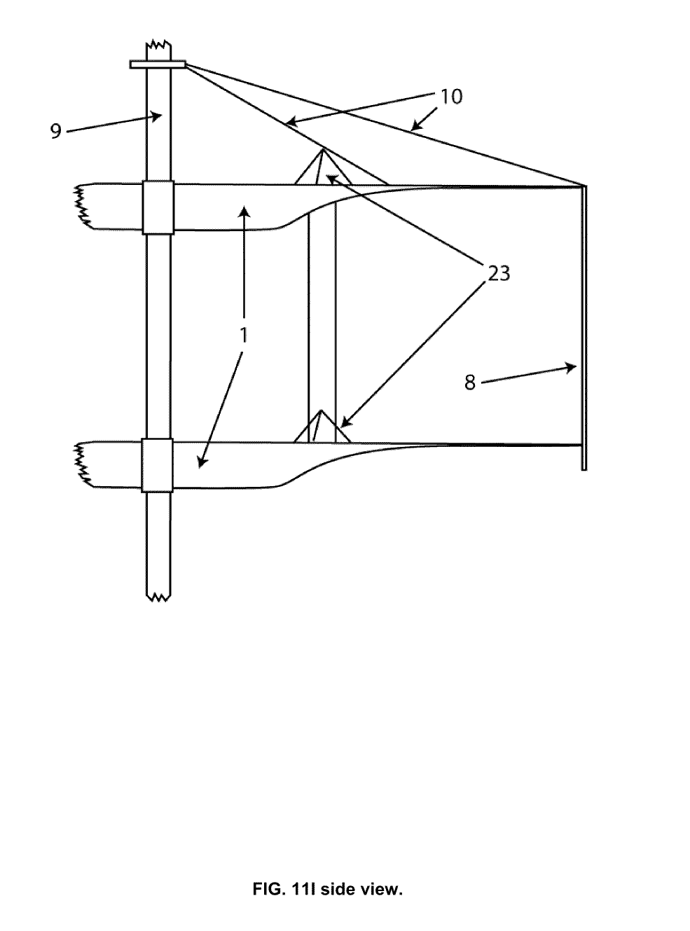

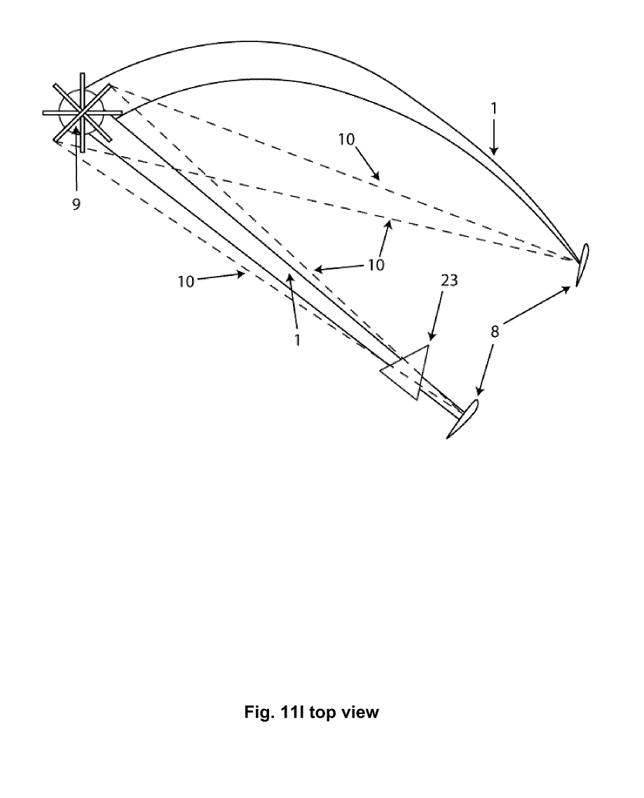

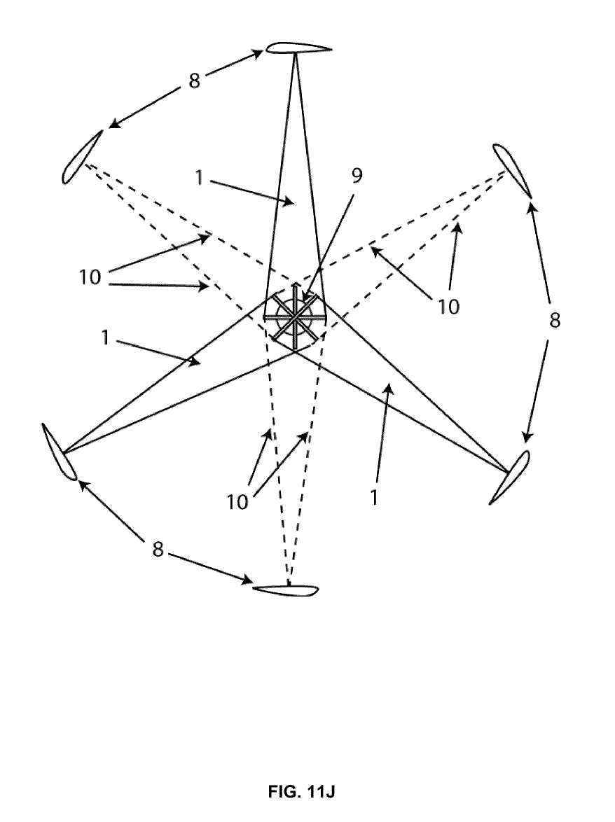

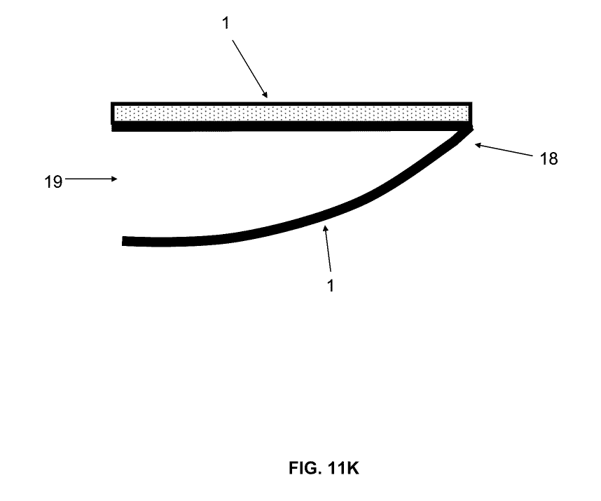

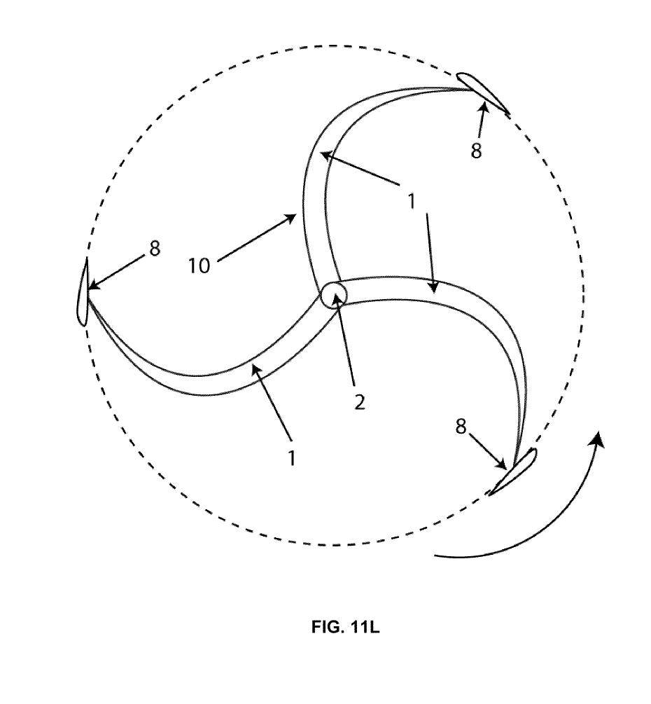

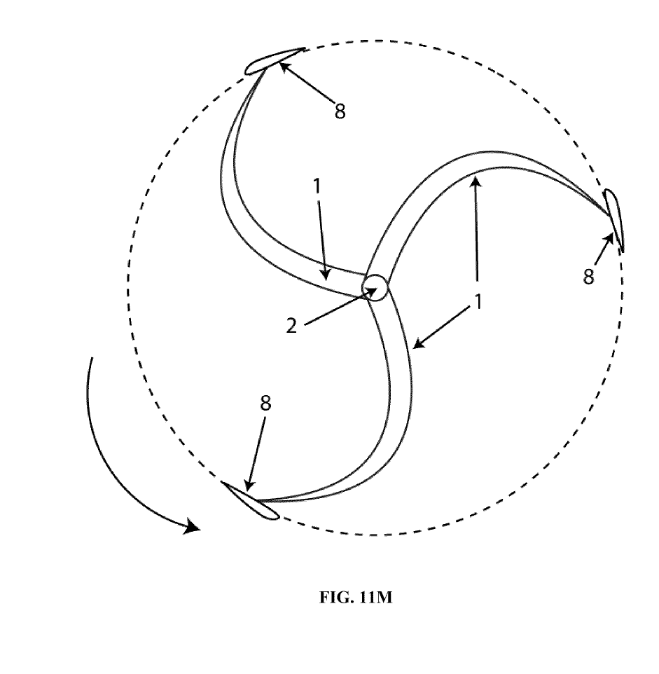

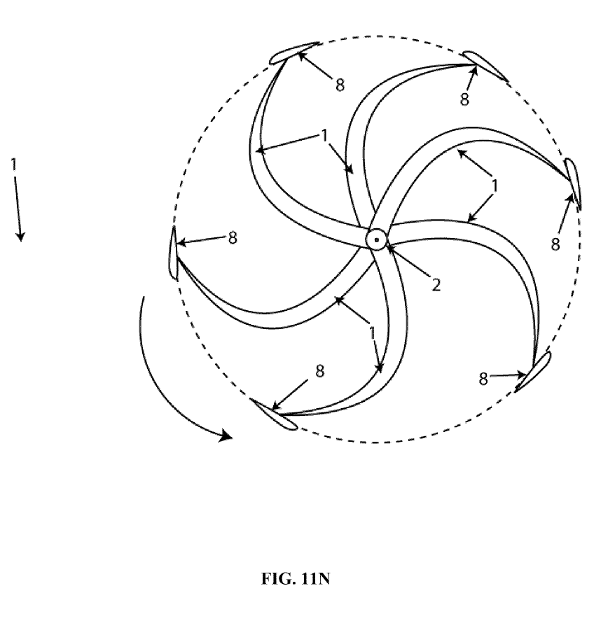

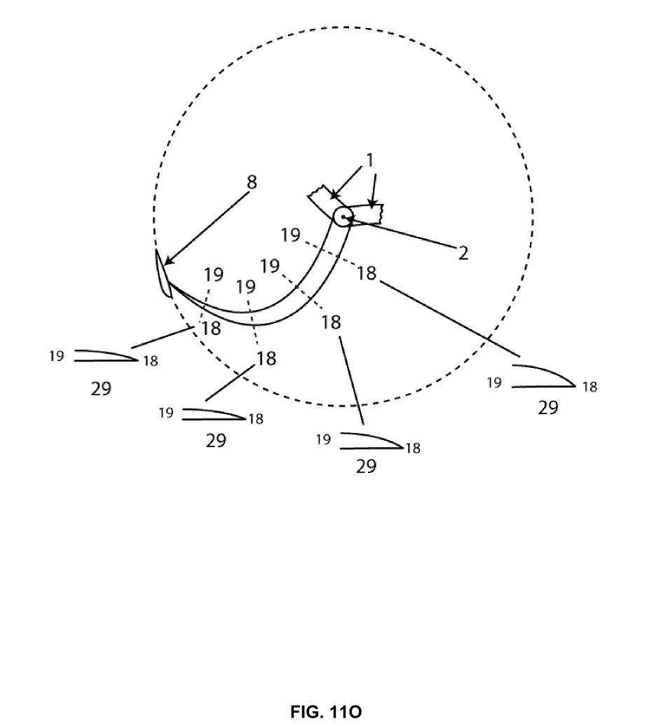

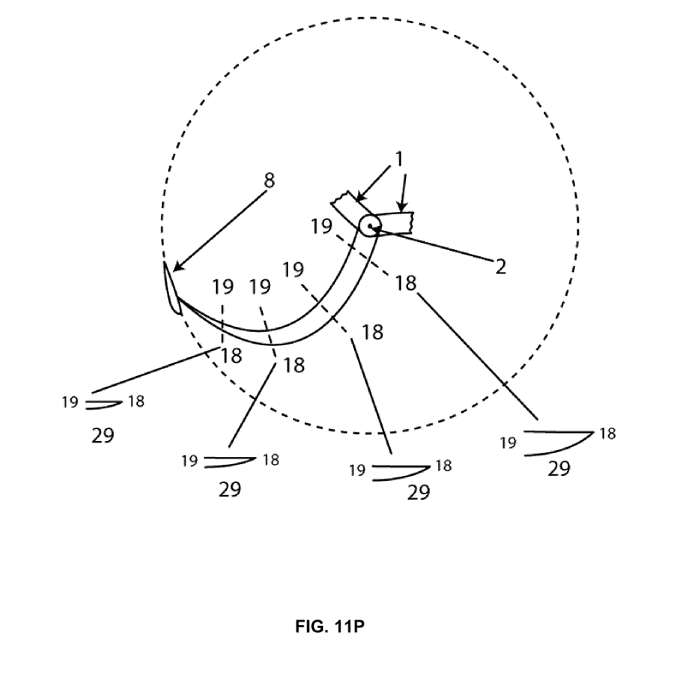

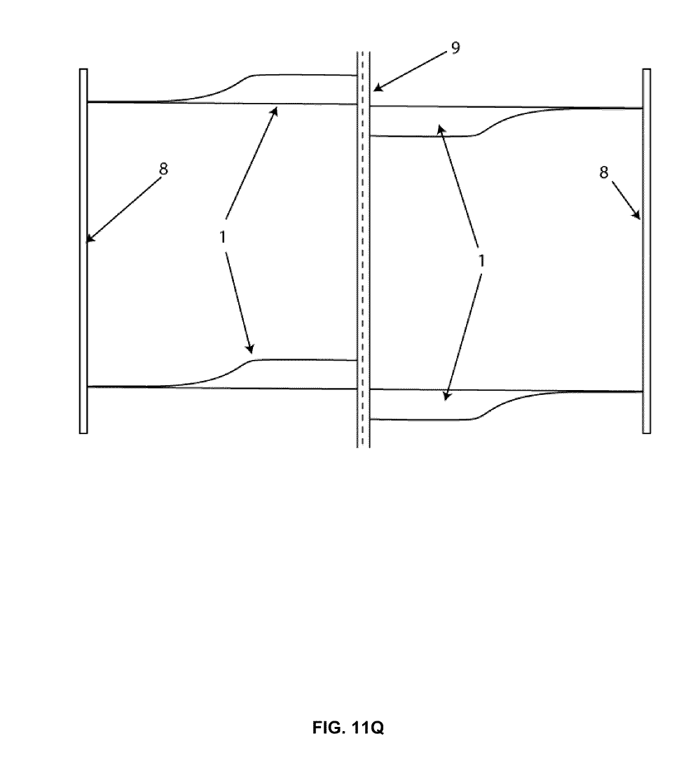

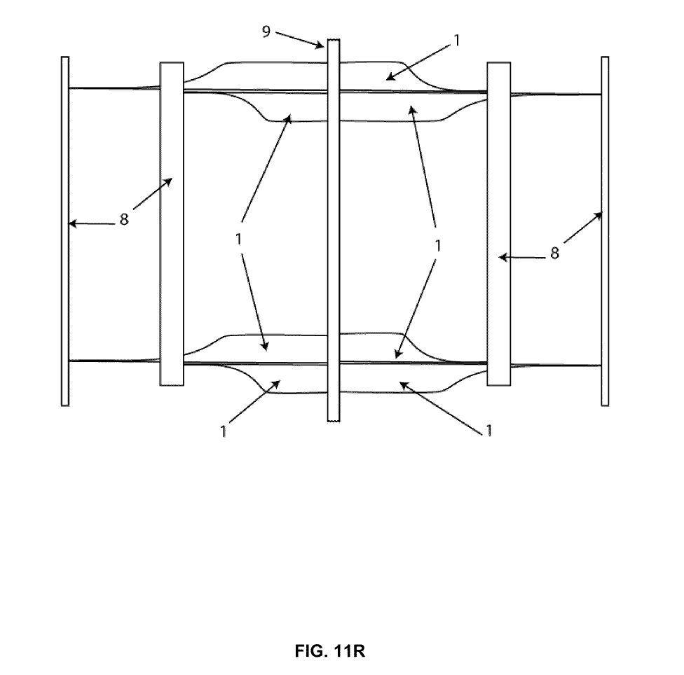

In some embodiments of the invention, multiple airfoils are suspended at or near the ends of AIVA rotor blades. A top view or a two-blade rotor with three airfoils per blade is shown in FIG. 11B and a top view of a three-blade rotor with two airfoils per blade is show in FIG. 11A. An alternative embodiment is shown in FIG. 11C where the spiraled or curved arms (e.g., extending non-linearly in a radial direction) have an extended length before supporting four vertical airfoils near the end of the arm. FIG. 11D shows a bird's eye view of an alternative embodiment. Using multiple airfoils on each rotor has the potential to improve overall efficiency because the change in airflow around a leading airfoil can produce a wake that increases the lift on trailing airfoils. The component of this lift in the direction of motion tends to offset the drag induced by additional airfoils. In one embodiment, movable cone-like air catching devices, or other wind catching structure, can be incorporated into the AIVA blades that are used to support the airfoils. An example of this is illustrated in FIG. 11E.

In one embodiment of the invention, six AIVA blades per rotor and six airfoils are used, where three of the AIVA blades are curved and three are straight. A top view of this embodiment is provided in FIG. 11F where optional movable cone-like wind catching devices are integrated into the straight blades of the AIVA rotor. There are overlapping regions between the straight blades and the curved blades in the region close to the rotation axis. The straight blades are flat and the curved blades are flat at the top so that the blades fit closely together where they overlap. This overlap provides for an effectively thicker part in this region which gives improved structural stability. FIG. 11G shows a bird's eye view of this embodiment. Side and top views are shown in FIGS. 11H and 11I. A top view of a guy wire assembly that can be used to stabilize the structure is shown in FIG. 11J. Here it can be seen that a center structure is used to hold two separated guy wires for each rotor blade. This increases stability since any deviation in the position of the airfoil from the desired position will immediately increase the tension in at least one of the guy wires. A cross section of the overlap area of the curved and straight blades is shown in FIG. 11K. The moveable cone-like structure (or other wind catching structure) shown in FIG. 11F is optional. This wind catching structure will increase the total energy production but may increase production and maintenance costs. In environments where the wind speeds are often low, the extra costs associated with the wind catching structure, such as, e.g., the cone-like structure (which may be moveable or stationary) may be justified, while in other environments it may be more economical not to use the wind catching structure.

In a preferred embodiment of the disclosure, six AIVA blades per rotor and six airfoils are used, where each of the six AIVA blades are curved. The six curved blades can be constructed from two sets of three blades. This is illustrated in FIG. 11L, which shows an upper set of three blades, FIG. 11M, which shows a lower set of three blades, and FIG. 11N, which shows the two sets of blades combined to form a six-blade rotor. Cross-sectional views of several positions on the upper set of blades is shown in FIG. 11O and similarly FIG. 11P shows the cross sections 29 on the lower set of blades. The upper blades have a high drag B-side area that extends upward above an almost flat bottom surface, while the lower blades have a high drag B-side area that extends downward below an almost flat top surface. In this way, the drag areas of the upper three blades do not significantly interfere aerodynamically with the drag areas of the lower three blades. A six-blade rotor constructed from two three blade rotors in this way is placed near the top of six vertical airfoils and another six-blade rotor is placed near the bottom of the six vertical airfoils in one preferred embodiment. A cross sectional view of this AIVA turbine is shown in FIG. 11Q and a side view of the turbine is shown in FIG. 11R. The blades are fully extended in these views.

By optimizing the aerodynamics of the AIVA blades, by optimizing their position relative to the airfoils, or by using adjustable thickness of AIVA blades, the aerodynamic interference between the AIVA blades and the airfoils may be kept to a minimum. This provides an improved efficiency compared to traditional Darrieus/Savonius combination rotors where the Savonius rotator is inside the Darrieus airfoils.

The advantages of many VAWT designs including many embodiments of the AIVA turbines, include being able to take advantage of any wind direction without having yaw control motors to rotate the structure. A particularly important advantage of AIVA turbines is their ability to produce electricity in relatively low wind environments.

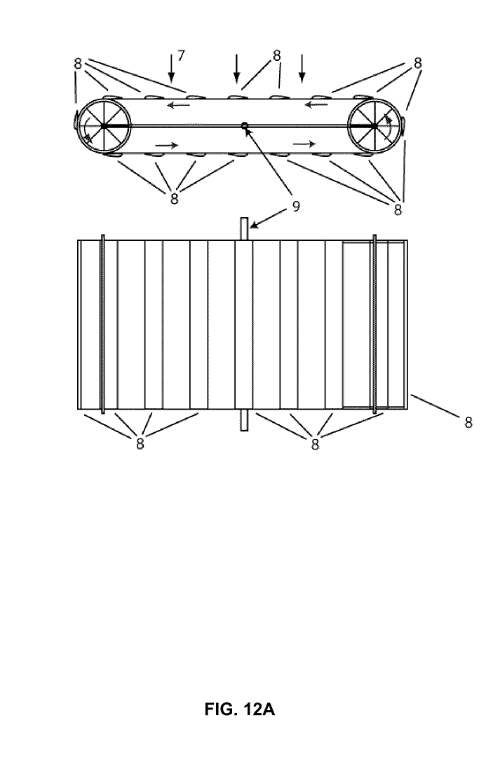

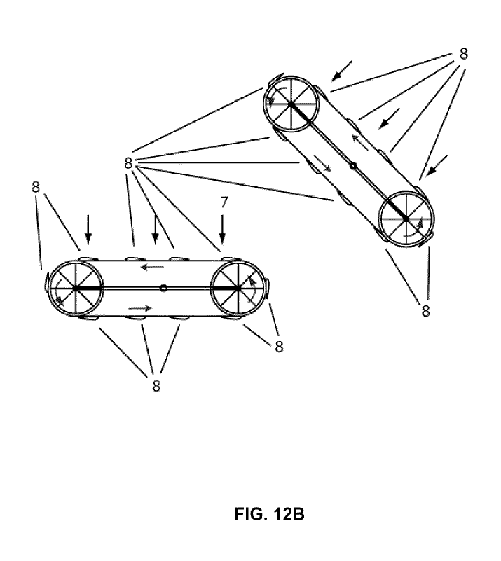

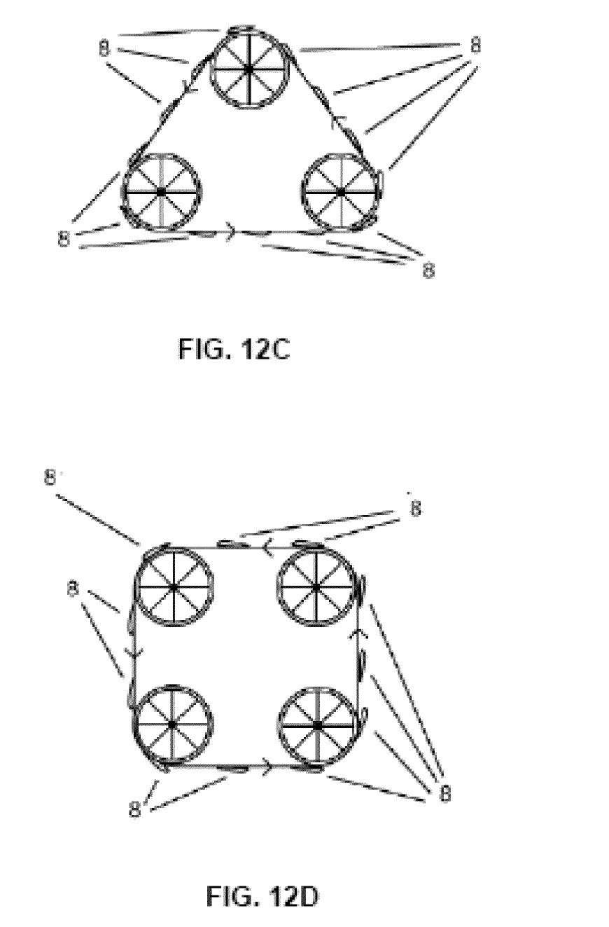

An alternative embodiment of the invention is shown in FIG. 12A. Here vertical airfoils are positioned around a closed loop. The loop is formed from a moving belt or moving chains that wrap around wheels at the ends of the loops and the airfoils move around the loop. The physics here is similar to that of an H-rotor except that now the direction of the wind is perpendicular to the direction of movement of the airfoils except for near the ends of the loop at the wheels. In this way the angle of attack of the relative airspeed to the airfoils can be kept at a constant optimum value through most of the movement of the airfoils and this can improve the efficiency compared to the traditional H-rotor design where the airfoils move on a circular path and have an angle of attack that constantly varies as the airfoils move around the path. However, in order for this design to be effective, the assembly will need to have a yaw control mechanism to move the rotor into the proper position relative to the wind direction. A traditional HAWT needs to be able to turn up to 180 degrees to face the wind direction, but because of the front/back symmetry of the present invention, it only needs to turn up to 90 degrees to face the wind. FIG. 12B shows how the rotor moves into the wind. Alternative embodiments are shown in FIGS. 12C and 12D where three or four wheels, respectively, are used instead of the two wheel designs of FIGS. 12A and 12B. These have the advantage of having to turn only 60 degrees or 45 degrees in order to face the wind. In some embodiments of the inventions, Savonius-type rotors are incorporated at the tops and/or the bottoms of the wheels at the corners of the tracks. These Savonius-type rotors add to the overall energy production and can act to jump start the airfoils.

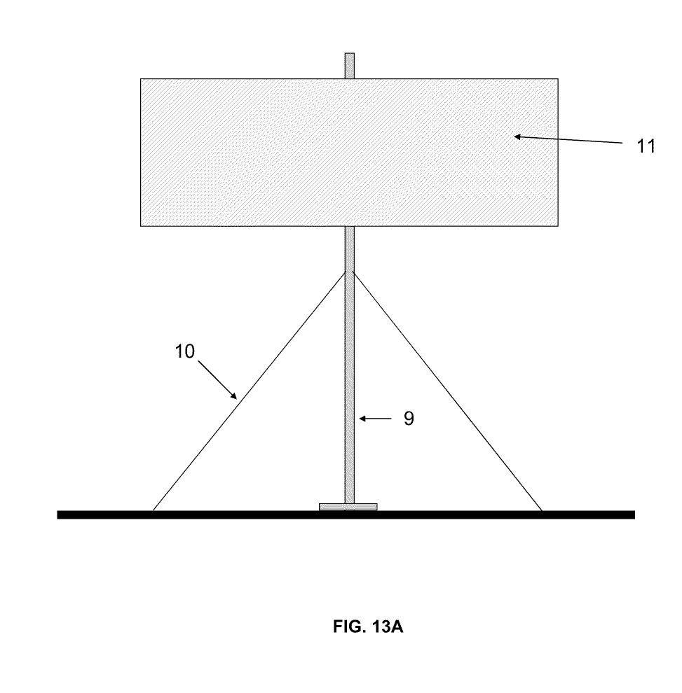

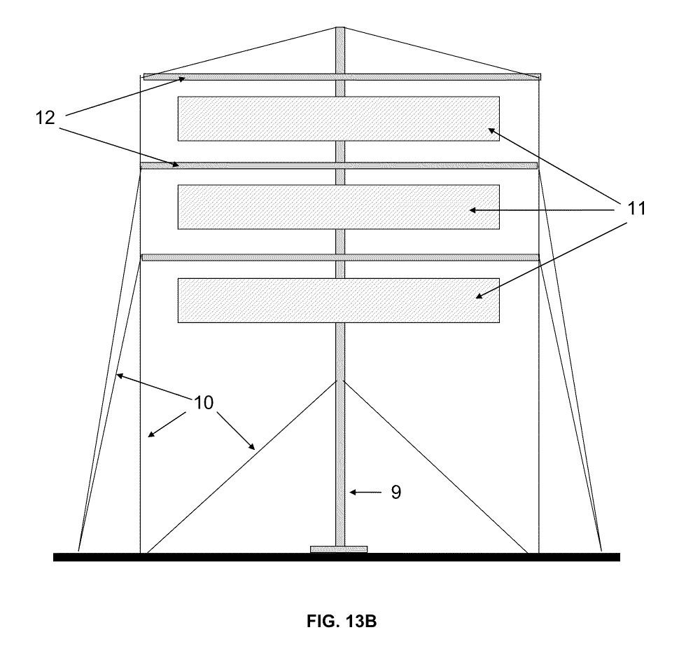

AIVA turbines can be used in any type of tower design. In one embodiment a single AIVA turbine 11 is attached to pole 9 that is supported by guy wires 10 as shown in FIG. 13A. In one embodiment of the invention, AIVA turbines 11 are used on a stand alone tower constructed from multiple rods that come together at the top end to support the rotors and flair apart at the ground end to provide stability. In an embodiment that can be used by an individual household, the overall height of the stand alone tower is about 10-20 meters. In another embodiment, the overall height is about 20-100 meters and in yet another embodiment the overall height is greater than 100 meters.

Since AIVA turbines are VAWTs, they are naturally suited to having multiple turbines used on the same tower. For example, in one embodiment, three AIVA turbines are attached to the same tower. Other embodiments may have more or less than three turbines per tower. The separate turbines rotate independently of each other and can be arranged to rotate in opposite directions to minimize or eliminate total angular momentum and associated torques. In one embodiment of the invention several AIVA turbines are used where the AIVA turbine sweep out a length about 50 meters across and are about 15 meters in height. In one embodiment four such turbines are used per tower with a spacing of about 10 meters between turbines and a height at the top turbine of about 120 meters.

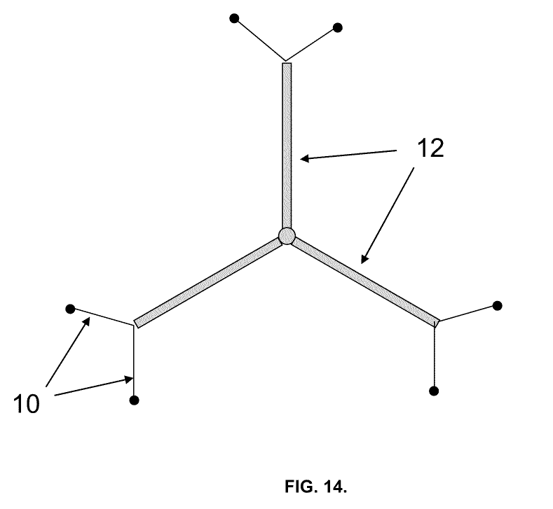

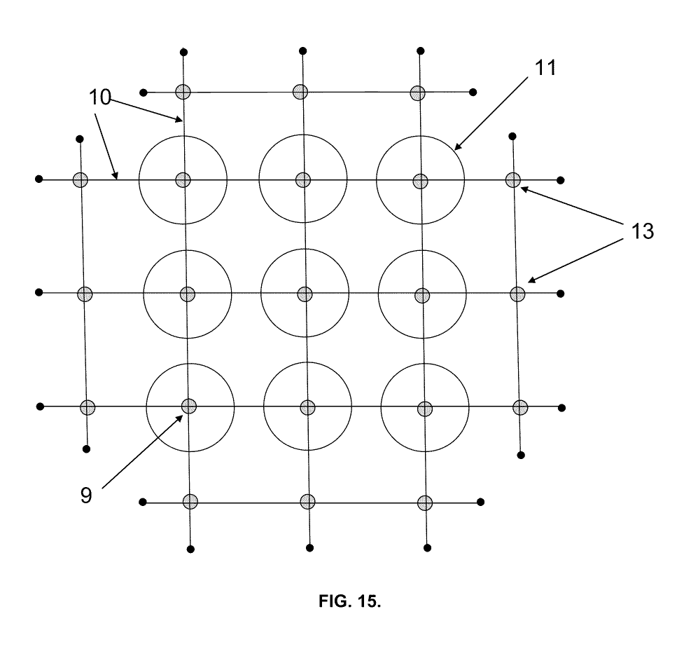

In another embodiment of the disclosure, several AIVA turbines 11 are mounted to a tall tower that uses guy wires 10 for support as follows, as shown in FIG. 13B. Guy wires 10 are attached to the top of the tower and then run through spreader beams that hold the guy wires away from the rotors. There can be multiple spreader beams used. Spreader beams 12 can be used above the top AIVA turbine and between any pairs of turbines. Guy wires 10 can run from spreader beam 12 to a lower spreader beam or from a spreader beam to an anchor in the ground. The spreader beams 12 are attached to the tower with a ball and socket at the connection between spreader beam 12 and the tower in order to reduce or eliminate stress of bending moment. Like other guyed tower designs, the bottom of the tower can connect to the ground with a ball and socket mount that allows for some rotation to relieve stress. An embodiment using three AIVA turbines 11 with spreader beams 12 and guy wires 10 is shown in FIG. 13B. A top view of one embodiment of spreader breams 12 is shown in FIG. 14. In one embodiment, the tower height is about 500 meters. In another embodiment, the tower height is about 100 meters. Using guy wires with spreader beams in this way allows for taller towers to be used which in turn allows more power to be produced for a given land area.

FIG. 13B illustrates an example of a vertical turbine assembly including a longitidunal support member and a plurality of turbines 11 each coupled to the longitudinal support member at a different vertical position. Each of the turbines 11 may include at least one vertical axis rotor. The vertical axis rotor may include at least one rotor blade configured to rotate about the vertical rotational axis along a rotational plane substantially orthogonal to the vertical rotational axis. The rotor blade includes a leading edge and trailing edge extending from an inner diameter to an outer diameter of the circular path followed by the at least one rotor blade about the rotational axis, and a distal portion and a proximal portion with respect to the vertical rotational axis. The rotor blades may be the same or similar to one or more of the examples described herein. In some examples, one or more of the turbines may include one or more blades coupled to vertical airfoils. For examples, a turbine 11 may include first and second rotor at different vertical positions and coupled to one another via vertically oriented airfoils. Each turbine 11 in FIG. 13B may rotate independently of one another. In some examples, each turbine turns the same shaft, e.g., within the longitudinal support member.

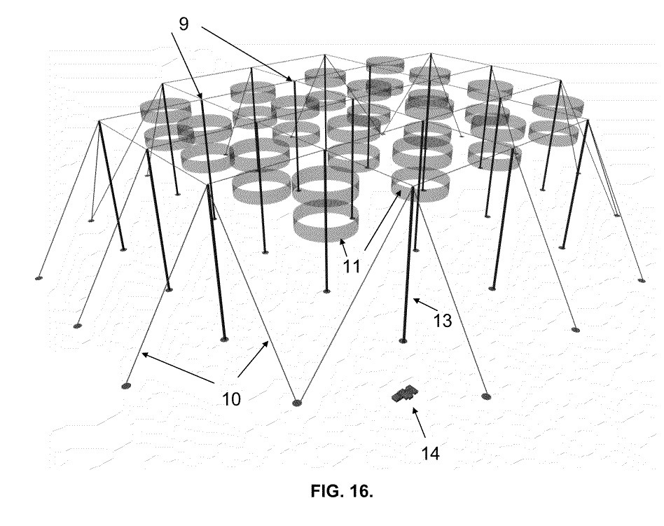

A wind farm using AIVA turbines can be constructed by using an array of towers guyed together to support the turbines. FIG. 15 shows a top view of an array of nine wind turbine towers 9 and twelve supporting poles 13 connected by guy wires 10. FIG. 16 shows a birds-eye view of an array of AIVA turbines 11. House 14 is included in FIG. 16 to give an impression of overall size. Only the top level of guy wires is shown for simplicity, but guy wires between top and bottom rotors and below the bottom-most rotors can be utilized. The guy wires between towers provide overall stability to the structure and allow for a smaller tower width than would otherwise be possible. This allows for a substantial weight reduction compared to traditional tower designs. In one embodiment, guy wires between towers are utilized at the top of the towers, in planes between rotors, and just below the bottom layer of rotors. In another embodiment, guy wires are used between the tower shaft below the bottom layer of rotors and the ground for additional stability. A combination of wires and rigid vertical towers with or without spreader beams create a structure of a network of wire-connected towers equipped with AIVA turbines, where the stress distributions are such that towers of the network bear almost exclusively compression stress without any significant bending moment stress, while guy wires bear pure tensional stress. This is similar to the proper distribution of compressional stress in a typical modern design of a suspension bridge where pure tensional stress is distributed on wires which connect the top of the bridge towers with horizontal bridge spans.

In one embodiment of the invention, an array of towers are guyed together in order to provide stability at altitudes exceeding 500 meters. In other embodiments, the tower heights are about 100 meters. These embodiments allow relatively higher energy production than traditional HAWTs due to their height affording more reliable high wind speeds. Guyed arrays of VAWT offer more economical construction costs since much of their support is generated by the guy wires easing the requirement for a massive foundation.

A problem with any wind turbine system is that the wind does not always have sufficient speed to generate significant power. One aspect of the present invention is to provide an energy storage mechanism to store energy generated during high wind conditions for use when wind speeds are low. In one embodiment, the energy storage mechanism comprises a massive flywheel rotating at high angular speeds that stores energy. A motor/generator structure, which is connected to the flywheel, is used as a motor when the wind speeds are high and some of the electrical energy produced by the wind turbine is converted to kinetic energy of the flywheel. When the wind speeds are low, the motor/generator structure is used as a generator that converts the kinetic energy of the flywheel into electrical energy. The energy from the wind turbines and from the flywheels can be supplemented by solar energy. In one embodiment of the present disclosure, solar panels are integrated on the top surfaces of the AIVA blades of the AIVA rotors for extra energy generation.

AIVA turbines can be used in any area where traditional turbines are used. AIVA turbines are particularly effective in areas where wind speed is not very high or varies rapidly or frequently as these types of wind patterns would give difficulty to traditional designs. AIVA turbines can also be used as water turbines to extract energy from water currents.

AIVA turbines can be effectively used on large ships since wind is typically available at sea and the omni-directional nature of the AIVA turbines would be beneficial. AIVA turbines can be relatively easily installed on extensions of masts of large ships.

The above embodiments are for illustrative purposes only and the dimensions can be varied arbitrarily within the scope of the invention.

The disclosure includes the following embodiments:

One embodiment of the disclosure is an AIVA rotor blade with an A-side and a B-side and a Zone A, a Zone B, and a Zone C, wherein the A-side is aerodynamically shaped so that it has a low drag coefficient and the B-side has a high drag coefficient in Zone A and a low drag coefficient in Zone C, and the change in cross-sectional shape from the Zone A shape to the Zone C shape varies continuously through Zone B.

Another embodiment of the disclosure is an AIVA rotor blade with an A-side and a B-side and a Zone A, and a Zone C, wherein the A-side is aerodynamically shaped so that it has a low drag coefficient and the B-side has a high drag coefficient in Zone A and a low drag coefficient in Zone C, and the radial length of Zone C is greater than ½ of the radial length of Zone A.

Another embodiment of the disclosure is an AIVA rotor blade with an A-side and a B-side and a Zone A and a Zone C, wherein the A-side is aerodynamically shaped so that it has a drag coefficient of less than about ½ and the B-side has a drag coefficient of greater than about 1 in Zone A and a drag coefficient of less than about ½ in Zone C.

Another embodiment of the disclosure is an AIVA rotor blade wherein the ratio of drag coefficient for airflow on the A-side of the AIVA rotor in Zone A to the drag coefficient for wind incident on the B-side of the AIVA rotor in Zone A is greater than 2.

Another embodiment of the disclosure is an AIVA rotor blade wherein the ratio of drag coefficient for airflow on the A-side of the AIVA rotor in Zone A to the drag coefficient for wind incident on the B-side of the AIVA rotor in Zone A is greater than 5.

Another embodiment of the disclosure is an AIVA turbine comprising a first AIVA rotor and a second AIVA rotor positioned above or below the first AIVA rotor.

Another embodiment of the disclosure is an AIVA turbine comprising vertically positioned airfoils, and two pairs of AIVA rotors, wherein one pair AIVA rotors are positioned at the top and the bottom of the vertically positioned airfoils, and the second pair of AIVA rotors are positioned directly under the top AIVA rotor and directly above the bottom AIVA rotor and wherein the secondary rotors have airfoil shaped regions near their ends.

Another embodiment of the disclosure is an AIVA turbine comprising three vertically oriented airfoils, which are supported by three AIVA blades of a 3-blade AIVA rotor at the upper position of airfoils and another three AIVA blades of another 3-blade AIVA rotor at the lower position of the airfoils.

Another embodiment of the disclosure is an AIVA turbine comprising six vertically oriented airfoils, which are supported by six AIVA blades of a 6-blade AIVA rotor at the upper position of airfoils and another six AIVA blades of another 6-blade AIVA rotor at the lower position of the airfoils and wherein three of the six AIVA blades of each AIVA rotor are curved and three are substantially straight.

Another embodiment of the disclosure is an AIVA turbine comprising six vertically oriented airfoils, which are supported by six AIVA blades of a 6-blade AIVA rotor at the upper position of airfoils and another six AIVA blades of another 6-blade AIVA rotor at the lower position of the airfoils and wherein all six AIVA blades of each AIVA rotor are curved.

Another embodiment of the disclosure is an AIVA turbine comprising a plurality of vertically oriented airfoils that are constrained to move on a closed-loop track.

Another embodiment of the disclosure is an AIVA turbine comprising a plurality of vertically oriented airfoils that are constrained to move on a closed-loop track wherein two or more wheels are used to define the boundaries of the track and drag based rotors are incorporated into or onto the wheels.

Another embodiment of the disclosure comprises one or more AIVA turbines on a tower with spreader beams located between the AIVA turbines, wherein the tower is guyed to the ground through the use of guy wires that run through the spreader beams.

Another embodiment of the disclosure is a wind farm comprising multiple turbine towers and multiple support towers wherein each turbine tower supports one or more AIVA turbines, and the turbine towers are guyed together and guyed to support towers at the boundary of the group of turbine towers and wherein the support towers are guyed to the ground.

Another embodiment of the disclosure comprises an energy storage system that includes rotating flywheels which can store extra wind generated energy when wind is strong and supply electrical energy when the wind is weak.

Another embodiment of the disclosure relates to a vertical axis wind turbine assembly comprising at least two longitudinal support members defining a vertical axis; a first line coupled to the at least two longitudinal support members at a first vertical position, the first line moveable about the at least two longitudinal support member along a first plane substantially orthogonal to the vertical axis; a second line coupled to the at least two longitudinal support members at a second vertical position; the second line moveable about the at least two longitudinal support member along a second plane substantially orthogonal to the vertical axis; and a plurality of vertically oriented airfoils coupled to the first line and second line and dispersed about a perimeter of a rotational path of the first and second lines about the at least two longitudinal support members, wherein the plurality of vertically oriented airfoils are configured to drive the first and second lines around the rotational path.

Various embodiments of the disclosure have been described. These and other embodiments are within the scope of the following claims.

1. A vertical axis wind turbine assembly comprising:
a longitudinal support member defining a vertical rotational axis; and
at least one vertical axis rotor, the vertical axis rotor including at least one rotor blade configured to rotate about the vertical rotational axis along a rotational plane substantially orthogonal to the vertical rotational axis, wherein the rotor blade extends radially outwardly from the vertical rotational axis along a nonlinear path in the rotational plane, and including a concave cross-section that tapers toward a distal end of the blade.

2. The vertical axis wind turbine assembly of claim 1, wherein the at least one rotor blade including the concave cross-section defines an opening face defining a plane that is substantially orthogonal to the rotational plane.

3. The vertical axis wind turbine assembly of claim 1, further comprising at least one wind catching structure coupled to a portion of the at least one rotor blade, wherein the wind catching structure is configured to increase drag coefficient of the portion of the at least one rotor blade.

4. The vertical axis wind turbine assembly of claim 3, wherein the at least one wind catching structure comprises one of a cone-shaped or pyramid shaped member defining an opening face defining a plane that is substantially orthogonal to the rotational plane.

5. The vertical axis wind turbine assembly of claim 3, wherein the at least one wind catching structure comprises a flap coupled to the blade via a hinge, wherein the flap is configured to move about the hinge to selectively increase and decrease a vertical thickness of the proximal portion of the blade.

6. The vertical axis wind turbine assembly of claim 3, wherein the at least one wind catching structure is moveably attached to the proximal portion of the at least one blade such that the at least one wind catching structure is translatable radially outwardly towards a distal end of the at least one rotor blade.

7. The vertical axis wind turbine assembly of claim 3, wherein the wind catching structure comprises a concave structure that extends vertically from the at least one rotor blade and that defines an opening face defining a plane that is substantially orthogonal to the rotational plane.

8. The vertical axis wind turbine assembly of claim 3, wherein the at least one wind catching structure is coupled to at least one of a distal portion or proximal portion of the at least one rotor blade.

9. The vertical axis wind turbine assembly of claim 1, further comprising at least one vertically oriented airfoil coupled to the distal portion of the at least one rotor blade.

10. The vertical axis wind turbine assembly of claim 9, wherein the at least one rotor blade comprises at least one first rotor blade at a first vertical position on the longitudinal support member and at least one second rotor blade at a second vertical position on the longitudinal support member, wherein the at least one vertical airfoil is coupled to both the at least one first rotor blade and at least one second rotor blade.

11. The vertical axis wind turbine assembly of claim 9, wherein a first portion of the at least one airfoil is coupled to the at least one rotor blade and a second portion of the at least one airfoil is coupled to the longitudinal support member via a guy wire.

12. The vertical axis wind turbine assembly of claim 9, wherein the vertical airfoil is coupled to a distal end of the at least one rotor blade.

13. The vertical axis wind turbine assembly of claim 1, wherein the at least one rotor blade comprises at least one first rotor blade at a first vertical position on the longitudinal support member and at least one second rotor blade at a second vertical position on the longitudinal support member.

14. The vertical axis wind turbine assembly of claim 13, wherein the at least one first rotor blade extends outwardly from the vertical axis in a different radial direction than the at least one second rotor blade.

15. The vertical axis wind turbine assembly of claim 1, further comprising at least one guy wire coupled to the longitudinal support member to stabilize the longitudinal support member.

16. The vertical axis wind turbine assembly of claim 1,
wherein the longitudinal support member comprises a first longitudinal support member,
further comprising at least one second longitudinal support member and at least one guy wire, wherein the at least one guy wire is coupled to the first longitudinal support member, the at least one second longitudinal support member, and a ground support to stabilized the assembly.

17. The vertical axis wind turbine assembly of claim 1, wherein the at least one rotor blade extends radially outwardly along a nonlinear path in the rotational plane.

18. A vertical axis wind turbine assembly comprising:
a longitudinal support member defining a vertical rotational axis; and
at least one vertical axis rotor, the vertical axis rotor including at least one rotor blade configured to rotate about the vertical rotational axis along a rotational plane substantially orthogonal to the vertical rotational axis,
wherein the rotor blade includes a leading edge and trailing edge extending from an inner diameter to an outer diameter of the circular path followed by the at least one rotor blade about the rotational axis, and a distal portion and a proximal portion with respect to the vertical rotational axis,
wherein the trailing edge of the proximal portion exhibits a first drag coefficient that is greater than: a second drag coefficients exhibited by the leading edge of the proximal portion; a third drag coefficient exhibited by the leading edge of the distal portion; and a fourth drag coefficient exhibited by the trailing edge of the distal portion.

19. The vertical axis wind turbine assembly of claim 18, wherein the leading edge of the proximal portion comprises a substantially flat surface oriented substantially orthogonal to the rotational plane.

20. The vertical axis wind turbine assembly of claim 18, wherein the at least one rotor blade including the concave cross-section defines an opening face defining a plane that is substantially orthogonal to the rotational plane.

21. The vertical axis wind turbine assembly of claim 18, further comprising at least one wind catching structure coupled to a portion of the at least one rotor blade, wherein the wind catching structure is configured to increase drag coefficient of the portion of the at least one rotor blade.

22. The vertical axis wind turbine assembly of claim 21, wherein the at least one wind catching structure comprises one of a cone-shaped or pyramid shaped member defining an opening face defining a plane that is substantially orthogonal to the rotational plane.

23. The vertical axis wind turbine assembly of claim 21, wherein the at least one wind catching structure comprises a flap coupled to the blade via a hinge, wherein the flap is configured to move about the hinge to selectively increase and decrease a vertical thickness of the proximal portion of the blade.

24. The vertical axis wind turbine assembly of claim 21, wherein the at least one wind catching structure is moveably attached to the proximal portion of the at least one blade such that the at least one wind catching structure is translatable radially outwardly towards a distal end of the at least one rotor blade.

25. The vertical axis wind turbine assembly of claim 21, wherein the wind catching structure comprises a concave structure that extends vertically from the at least one rotor blade and that defines an opening face defining a plane substantially orthogonal to the rotational plane.

26. The vertical axis wind turbine assembly of claim 21, wherein the at least one wind catching structure is coupled to at least one of a distal portion or proximal portion of the at least one rotor blade.

27. The vertical axis wind turbine assembly of claim 18, further comprising at least one vertically oriented airfoil coupled to the distal portion of the at least one first rotor blade.

28. The vertical axis wind turbine assembly of claim 27, wherein the at least one rotor blade comprises at least one first rotor blade at a first vertical position on the longitudinal support member and at least one second rotor blade at a second vertical position on the longitudinal support member, wherein the at least one vertical airfoil is coupled to both the at least one first rotor blade and at least one second rotor blade.

29. The vertical axis wind turbine assembly of claim 27, wherein a first portion of the at least one airfoil is coupled to the at least one rotor blade and a second portion of the at least one airfoil is coupled to the longitudinal support member via a guy wire.

30. The vertical axis wind turbine assembly of claim 27, wherein the vertical airfoil is coupled to a distal end of the at least one rotor blade.

31. The vertical axis wind turbine assembly of claim 18, wherein the at least one rotor blade comprises at least one first rotor blade at a first vertical position on the longitudinal support member and at least one second rotor blade at a second vertical position on the longitudinal support member.

32. The vertical axis wind turbine assembly of claim 31, wherein the at least one first rotor blade extends outwardly from the vertical axis in a different radial direction than the at least one second rotor blade.

33. The vertical axis wind turbine assembly of claim 18, further comprising at least one guy wire coupled to the longitudinal support member to stabilize the longitudinal support member.

34. The vertical axis wind turbine assembly of claim 18,
wherein the longitudinal support member comprises a first longitudinal support member,
further comprising at least one second longitudinal support member and at least one guy wire, wherein the at least one guy wire is coupled to the first longitudinal support member, the at least one second longitudinal support member, and a ground support to stabilized the assembly.

35. The vertical axis wind turbine assembly of claim 18, wherein the at least one rotor blade extends radially outwardly along a nonlinear path in the rotational plane.

36. A vertical axis wind turbine assembly comprising:
a longitudinal support member defining a vertical rotational axis; and
a plurality of turbines each coupled to the longitudinal support member at different vertical positions,
wherein each turbine comprises at least one vertical axis rotor, the vertical axis rotor including at least one rotor blade configured to rotate about the vertical rotational axis along a rotational plane substantially orthogonal to the vertical rotational axis,
wherein the rotor blade includes a leading edge and trailing edge extending from an inner diameter to an outer diameter of the circular path followed by the at least one rotor blade about the rotational axis, and a distal portion and a proximal portion with respect to the vertical rotational axis.

37. The vertical axis wind turbine assembly of claim 36, wherein at least one of the plurality of turbines comprises at least one vertically oriented airfoil couple to a first and second vertical axis rotors.
